(19) United States
(12) Patent Application Publication
(10) Pub. No.: US 2024/0077870 A1
(43) Pub. Date: Mar. 7, 2024

(54) ROBOT DEVICE, METHOD FOR CONTROLLING SAME, AND RECORDING MEDIUM HAVING PROGRAM RECORDED THEREON

(71) Applicant: SAMSUNG ELECTRONICS CO., LTD., Suwon-si (KR)

(72) Inventor: Sihyun Park, Suwon-si (KR)

(73) Assignee: SAMSUNG ELECTRONICS CO., LTD., Suwon-si (KR)

(21) Appl. No.: 18/388,607

(22) Filed: Nov. 10, 2023

Related U.S. Application Data
(63) Continuation of application No. PCT/KR2022/095097, filed on May 9, 2022.

(30) Foreign Application Priority Data
May 10, 2021 (KR) 10-2021-0060334

(51) Int. Cl. G05D 1/00; G05D 1/02; G06V 10/70; G06V 20/64; G06V 40/10

(52) U.S. Cl. CPC G05D 1/0011; G05D 1/0212; G05D 1/0246; G06V 10/70; G06V 20/64; G06V 40/10; G05D 2201/0203

(57) ABSTRACT

A robot device includes at least one processor configured to detect a person in a driving area of the robot device, based on a determination that no person is present in the driving area, recognize an object in an input image generated from the image signal using a cloud machine learning model, in a first mode, based on a determination that a person is present in the driving area, recognize the object in the input image generated from the image signal using an on-device machine learning model, in a second mode, and control the driving of the robot device through the moving assembly by using a result of recognizing the object, wherein the cloud machine learning model operates on a cloud server connected through the communication interface, and the on-device machine learning model operates on the robot device.

### CROSS-REFERENCE TO RELATED APPLICATIONS

This application is a bypass continuation of International Application No. PCT/KR2022/095097, filed in the Korean Intellectual Property Office on May 9, 2022, which claims priority from Korean Patent Application No. 10-2021-0060334, filed in the Korean Intellectual Property Office on May 10, 2021, the disclosures of which are incorporated by reference herein in their entireties.

### BACKGROUND

### 1. Technical Field

Embodiments of the disclosure relates to a robot device, a method of controlling the robot device, and a computer-readable recording medium having a computer program recorded thereon.

### 2. Background

Technologies that self-classify or learn the characteristics of data obtained from cameras, microphones, sensors, etc. require high-performance computing power. For this reason, a method in which an electronic device transmits obtained data to a remote cloud server without directly processing the obtained data, requests the cloud server to analyze the data, and receives an analysis result is used. In this case, the server processes data received from the electronic device by using a machine learning algorithm based on big data collected from a plurality of electronic devices, and transmits a processing result value to the electronic device in a form usable by the electronic device. The electronic device may perform a predefined operation by using a result value received from the cloud server. However, when images captured by the electronic device are used for machine learning algorithm processing using the cloud server, there is a problem of having to transmit images or video data that users do not want to disclose to the cloud server. When users do not agree to transmit the collected data to the server so as to protect personal information, there is a problem that a cloud artificial intelligence (AI)-based control function using big data is not provided.

### SUMMARY

Embodiments of the disclosure provide a robot device, which drives while capturing an image, capable of ensuring user privacy by using a cloud machine learning model, a method of controlling the robot device, and a recording medium storing a computer program.

According to an aspect of an embodiment of the disclosure, a robot device including a moving assembly configured to move the robot device, a camera configured to generate an image signal by photographing surroundings of the robot device during driving of the robot device, a communication interface, and at least one processor configured to detect a person in a driving area of the robot device, based on a determination that no person is present in the driving area, recognize an object in an input image generated from the image signal using a cloud machine learning model, in a first mode, based on a determination that a person is present in the driving area, recognize the object in the input image generated from the image signal using an on-device machine learning model, in a second mode, and control the driving of the robot device through the moving assembly by using a result of recognizing the object, wherein the cloud machine learning model operates on a cloud server connected through the communication interface, and the on-device machine learning model operates on the robot device.

The robot device may further include an output interface, wherein the at least one processor may provide a notification recommending changing an operation mode to the second mode through the output interface when it is determined that the person is present in the driving area while operating in the first mode, and provide a notification recommending changing the operation mode to the first mode through the output interface when it is determined that no person is present in the driving area while operating in the second mode.

The at least one processor may determine whether the person is present in the driving area based on the object recognition result of the cloud machine learning model or the on-device machine learning model.

The communication interface may communicate with an external device including a first sensor detecting the person in the driving area, and the at least one processor may determine whether the person is present in the driving area based on a sensor detection value of the first sensor.

The communication interface may communicate with an area management system managing a certain area including the driving area, and the at least one processor may determine that no person is present in the driving area based on receiving going out information indicating that the area management system is set to a going out mode.

The communication interface may communicate with a device management server controlling at least one electronic device registered in a user account, and the at least one processor may determine whether the person is present in the driving area based on user location information or going out mode setting information received from another electronic device registered in the user account of the device management server.

The at least one processor may scan the entire driving area and determine whether the person is present in the driving area based on a scan result of the entire driving area.

The driving area may include one or more sub driving areas defined by splitting the driving area, and the at least one processor may recognize the object by operating in the first mode in a first sub driving area in which it is determined that no person is present, wherein the first sub driving area is among the one or more sub driving areas, and recognize the object by operating in the second mode in a second sub driving area in which it is determined that the person is present, wherein the second sub driving area is among the one or more sub driving areas.

The on-device machine learning model may operate in a normal mode in the second mode, and operates in a light mode with less throughput than the normal mode in the first mode, and the at least one processor may set the on-device machine learning model to the light mode while operating in the first mode, input the input image to the on-device machine learning model set to the light mode before inputting the input image to the cloud machine learning model, determine whether the person is detected based on an output of the on-device machine learning model set to the light mode, based on determining that no person is detected as an output of the on-device machine learning model set to the light mode, input the input image to the cloud machine learning model, and based on determining that the person is detected as an output of the on-device machine learning model set to the light mode, stop inputting the input image to the cloud machine learning model.

The at least one processor may provide a notification recommending changing an operation mode to the second mode when it is determined that the person is present in the driving area while operating in the first mode, and provide a notification recommending changing the operation mode to the first mode when it is determined that no person is present in the driving area while operating in the second mode, and the notification may be output through at least one device registered in a user account of a device management server connected through the communication interface.

The at least one processor may operate in the second mode in a privacy area, regardless of whether the person is detected, when the privacy area is set in the driving area.

The robot device may further include a cleaning assembly configured to perform at least one operation of vacuum suction or mop water supply, and the at least one processor may operate the cleaning assembly while driving in the driving area in the first mode and the second mode.

According to another aspect of an embodiment of the disclosure, a method of controlling a robot device including generating an input image by photographing surroundings during driving of the robot device, detecting a person in a driving area of the robot device, based on a determination that no person is present in the driving area, recognizing an object in an input image generated from the image signal using a cloud machine learning model in a first mode; based on a determination that a person is present in the driving area, recognizing the object in the input image generated from the image signal using an on-device machine learning model in a second mode; and controlling the driving of the robot device by using a result of recognizing the object, wherein the cloud machine learning model operates on a cloud server communicating with the robot device, and the on-device machine learning model operates on the robot device.

According to another aspect of an embodiment of the disclosure, provided is a non-transitory computer-readable recording medium having recorded thereon a computer program for performing the method of controlling the robot device, on a computer.

### BRIEF DESCRIPTION OF THE DRAWINGS

FIG. 1 is a diagram illustrating a robot device and a robot device control system according to an embodiment of the disclosure.

FIG. 2 is a block diagram illustrating a structure of a robot device according to an embodiment of the disclosure.

FIG. 3 is a diagram illustrating a method of controlling a robot device according to an embodiment of the disclosure.

FIG. 4 is a diagram illustrating an output of a machine learning model according to an embodiment of the disclosure.

FIG. 5 is a diagram illustrating a process of determining whether a person is present according to an embodiment of the disclosure.

FIGS. 6A and 6B are diagrams illustrating an operation of a robot device in a patrol mode performed according to an embodiment of the disclosure.

FIG. 7 is a diagram illustrating a driving area of a robot device according to an embodiment of the disclosure.

FIG. 8 is a diagram illustrating a control operation of a machine learning model of a robot device according to an embodiment of the disclosure.

FIG. 9 is a diagram illustrating an operation of a robot device according to an embodiment of the disclosure.

FIG. 10 is a diagram illustrating a configuration of a robot device according to an embodiment of the disclosure.

FIG. 11 is a diagram illustrating a condition for determining a mode change and a case where a mode conversion recommendation event occurs according to an embodiment of the disclosure.

FIG. 12 is a diagram illustrating an operation in which a robot device outputs a mode change recommendation message according to an embodiment of the disclosure.

FIG. 13 is a diagram illustrating an operation in which a robot device outputs a mode change recommendation message according to an embodiment of the disclosure.

FIG. 14 is a diagram illustrating a process in which a robot device transmits a mode change notification according to an embodiment of the disclosure.

FIG. 15 is a flowchart illustrating a process of outputting a notification through an external electronic device when a mode conversion recommendation event occurs in a first mode according to an embodiment of the disclosure.

FIG. 16 is a diagram illustrating a process of outputting a mode change recommendation message through an external device according to an embodiment of the disclosure.

FIG. 17 is a flowchart illustrating a process of outputting a notification through an external electronic device when a mode conversion recommendation event occurs in a second mode according to an embodiment of the disclosure.

FIG. 18 is a diagram illustrating a process of outputting a mode change recommendation message through an external device according to an embodiment of the disclosure.

FIG. 19 is a flowchart illustrating an operation of setting a privacy area or privacy time according to an embodiment of the disclosure.

FIG. 20 is a diagram illustrating a process of setting a privacy area according to an embodiment of the disclosure.

FIG. 21 is a diagram illustrating a process of setting a privacy area and a photographing prohibition area according to an embodiment of the disclosure.

FIG. 22 is a diagram illustrating a process of setting a privacy time according to an embodiment of the disclosure.

FIG. 23 is a diagram illustrating an example of a robot device according to an embodiment of the disclosure.

FIG. 24 is a diagram illustrating a structure of a cleaning robot according to an embodiment of the disclosure.

### DETAILED DISCLOSURE

The present specification describes and discloses principles of embodiments of the disclosure such that the scope of right of claims are clarified and one of ordinary skill in the art may implement embodiments of the disclosure described in the claims. The disclosed embodiments may be implemented in various forms.

Throughout the specification, like reference numerals denote like components. The present specification does not describe all components of the embodiments of the disclosure, and generic content in the technical field of the disclosure or redundant content of the embodiments is omitted. The term “module” or “unit” used in the specification may be implemented in software, hardware, firmware, or a combination thereof, and according to embodiments, a plurality of “modules” or “units” may be implemented as one element or one “module” or “unit” may include a plurality of elements.

In the description of an embodiment, certain detailed explanations of related art are omitted when it is deemed that they may unnecessarily obscure the essence of the disclosure. Also, numbers (for example, a first, a second, etc.) used in the description of the specification are merely identifier codes for distinguishing one component from another.

Also, in the present specification, it will be understood that when components are “connected” or “coupled” to each other, the components may be directly connected or coupled to each other, but may alternatively be connected or coupled to each other with an intervening component therebetween, unless specified otherwise.

Hereinafter, operation principles and various embodiments of the disclosure will be described with reference to accompanying drawings.

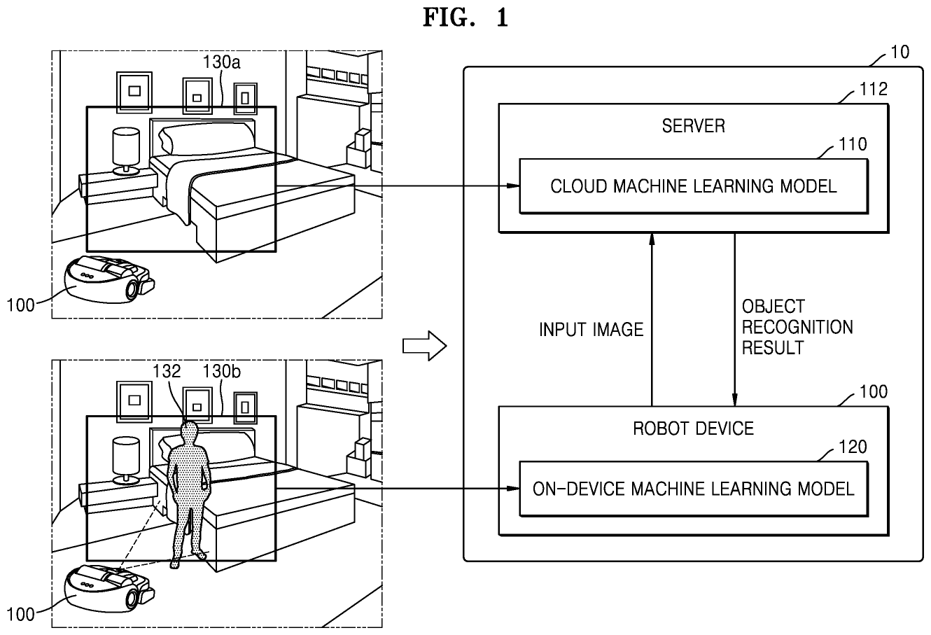

FIG. 1 is a diagram illustrating a robot device and a robot device control system according to an embodiment of the disclosure.

Embodiments of the disclosure relate to a robot device 100 driving in a certain area. The robot device 100 may provide various functions while driving in the certain area. The robot device 100 may be implemented in the form of, for example, a cleaning robot or a care robot providing a care service. In the disclosure, an embodiment in which the robot device 100 is a cleaning robot is mainly described. However, the robot device 100 may be implemented as a driving robot device of various types, and an embodiment of the robot device 100 is not limited to the cleaning robot.

The robot device 100 drives within a certain driving area. The driving area may be defined according to a certain criterion while the robot device 100 starts an operation, or may be set previously by a designer or a user. The driving area of the robot device 100 may be variously defined as a home, a store, an office, a specific outdoor space, etc. The driving area of the robot device 100 may be defined in advance by a wall, a ceiling, a sign, etc. For example, a robot device for home use may automatically recognize a wall (or ceiling) inside the house to define a driving area.

The robot device 100 drives while sensing the front by using a camera, sensor, etc. in the driving area. The robot device 100 includes a camera, and may drive by automatically avoiding obstacles within the driving area while sensing obstacles ahead by using input images 130a and 130b captured by the camera.

The robot device 100 according to embodiments of the disclosure recognizes an object from the input images 130a and 130b by using a machine learning model and controls driving. The machine learning model is a model trained by training data including a number of images. The machine learning model receives the input images 130a and 130b and outputs object information representing a type of an object and object area information representing an object area. The robot device 100 sets (plans) a driving path and avoids obstacles based on the object type information and the object area information output by the machine learning model. For example, the robot device 100 determines an optimal path in a driving space where there are no obstacle within the driving area, and performs an operation while driving along the optimal path. Also, when detecting an obstacle, the robot device 100 avoids the obstacle and sets the driving path. As described above, the robot device 100 obtains the object type information and the object area information from the input images 130a and 130b by using the machine learning model, and performs an operation of controlling the driving path.

A robot device control system 10 according to an embodiment of the disclosure includes a server 112 and the robot device 100. The server 112 corresponds to various types of external devices and may be implemented as a cloud server. The robot device 100 and the server 112 are connected over a network. The robot device 100 transmits the input images 130a and 130b and various control signals and data to the server 112. The server 112 outputs an object recognition result to the robot device 100.

The robot device 100 according to an embodiment of the disclosure uses both a cloud machine learning model 110 and an on-device machine learning model 120 for object recognition. The cloud machine learning model 110 is a machine learning model performed by the server 112. The on-device machine learning model 120 is a machine learning model performed by the robotic device 100. Both the cloud machine learning model 110 and the on-device machine learning model 120 receive the input images 130a and 130b and output the object type information and the object area information. The cloud machine learning model 110 and the on-device machine learning model 120 may be machine learning models having the same structure and parameter value. According to another example, structures and parameter values of the cloud machine learning model 110 and the on-device machine learning model 120 may be set differently.

When determining that there is no person in the driving area, the robot device 100 according to an embodiment of the disclosure operates in a first mode by using the cloud machine learning model 110. When determining that a person 132 is present in the driving area, the robot device 100 operates in a second mode by using the on-device machine learning model 120 without transmitting the input image 130b to the server 112.

The robot device 100 determines whether the person 132 is present in the driving area in various ways. For example, the robot device 100 determines whether the person 132 is present in the driving area by using the input images 130a and 130b captured by using the camera. For example, the robot device 100 may determine whether the person 132 is present in the driving area by using an output of the cloud machine learning model 110 or an output of the on-device machine learning model 120. As another example, the robot device 100 may include a separate sensor such as a lidar sensor or an infrared sensor, and determine whether the person 132 is present in the driving area by using a sensor detection value. As another example, the robot device 100 may determine whether the person 132 is present in the driving area by using information provided from an external device. Various embodiments regarding a method of determining whether the person 132 is present are described in detail below.

According to embodiments of the disclosure, when the robot device 100 captures the input images 130a and 130b by using the camera and transmits the input image 130a to the server 112 only when no person is present in the driving area, there is an effect of preventing a situation in which user privacy is violated.

The cloud machine learning model 110 may use a lot of resources and training data, and thus, its performance may be superior to that of the on-device machine learning model 120. The cloud machine learning model 110 may train a model based on big data collected under various user environment conditions, thereby recognizing many types of objects and achieving a high accuracy of object recognition. However, a user may not want a video taken by the user or user's family to be transmitted to the server 112, and a situation where privacy is not be protected by transmitting the input video to the server 112 may occur.

On the other hand, the computation performance of a control processing unit (CPU) used for driving and control processing in the robot device 100 is evolving into a low-cost and high-performance form, and in some cases, a neural processing unit (NPU) is separately embedded in the robot device 100 for efficient processing of a machine learning algorithm. In addition, it is possible for on-device to process a machine learning algorithm within a required time by using a computer language such as the graphics processing unit (GPU)-based Open CL, without using a remote cloud server. Compared to a method of using a cloud machine learning model using a cloud server, a method of using such an on-device machine learning model has advantages in terms of data processing speed and personal information protection because there is no network cost.

In another aspect, the on-device machine learning model has the advantage of receiving a highly personalized service as the scope of data collection for learning is limited to a home environment. However, when the robot device 100 needs to operate under conditions outside of normal use conditions, that is, when a condition that has never been learned in the home environment is suddenly given, there is a disadvantage that there is a high probability of occurrence of erroneous control compared to an operation of a cloud machine learning model that processes AI inference based on data collection from various users.

With regard to object recognition of a cleaning robot as an example, when using the on-device machine learning model 120, there is an advantage in that it is possible to directly use raw data as an input for AI inference without having to convert image or video input data collected from a camera while driving into a data form that is processable by the cloud machine learning model 110. In addition, network cost and delay time for transmitting the input images 130a and 130b to the server 112 are not required, and thus, a processing speed may be advantageous. However, considering computing power of the on-device, types of object recognition of the on-device machine learning model 120 may be more limited than those of the cloud machine learning model 110. As described above, when the object recognition performance is poor, problems such as a collision occurring while the robot device 100 is driving or pushing and passing by pet secretions without avoiding pet secretions may occur.

On the other hand, when a cleaning robot uses the cloud machine learning model 110, privacy protection that users are concerned about may not be guaranteed, but AI inference based on big data collected under various user environment conditions may be used, and thus, there is an advantage in improving the types and accuracy of recognizable objects or things.

In the embodiments of the disclosure, a situation where privacy is not protected in a process of using the cloud machine learning model 110 is protected as described above. In the embodiments of the disclosure, when it is determined that a person is present in the driving area of the robot device 100, the robot device 100 using the cloud machine learning model 110 may prevent from violating privacy by controlling the input image 130a not to be transmitted from the robot device 100 to the server 112. In addition, in the embodiments of the disclosure, when it is determined that no person is present in the driving area of the robot device 100, the robot device 100 may use the cloud machine learning model 110, thereby providing higher performance object recognition by using the cloud machine learning model 110 in a situation where user privacy is not violated.

The robot device 100 operates in the first mode when it is determined that no person is present in the driving area. The robot device 100 uses the cloud machine learning model 110 in the first mode. The robot device 100 transmits the input image 130a to the server 112 and requests object recognition from the cloud machine learning model 110. The server 110 receives the input image 130a and inputs the input image 130a to the cloud machine learning model 110. The cloud machine learning model 110 receives and processes the input image 130a, and outputs the object type information and the object area information. The server 112 transmits the object type information and the object area information output from the cloud machine learning model 110 to the robot device 100. The robot device 100 performs a certain driving control operation by using the object type information and the object area information received from the cloud machine learning model 110.

The robot device 100 operates in the second mode when it is determined that the person 132 is present in the driving area. The robotic device 100 uses the on-device machine learning model 120 in the second mode. The robot device 100 does not transmit the input image 130b to the server 112 in the second mode. The robot device 100 inputs the input image 130b to the on-device machine learning model 120 in the second mode. The on-device machine learning model 120 receives and processes the input image 130b, and outputs the object type information and the object area information. The robot device 100 performs a certain driving control operation by using the object type information and the object area information received from the on-device machine learning model 120.

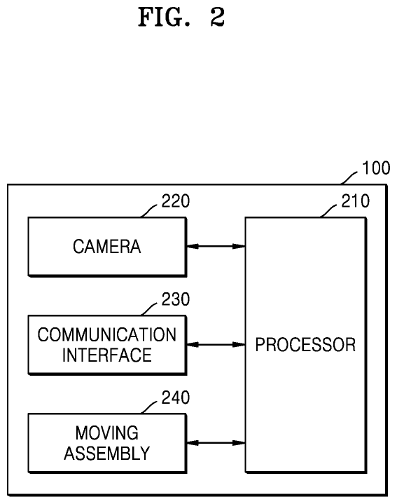

FIG. 2 is a block diagram illustrating a structure of a robot device according to an embodiment of the disclosure.

According to an embodiment of the disclosure, the robot device 100 includes a processor 210, a camera 220, a communication interface 230, and a moving assembly 240.

The processor 210 controls the overall operation of the robot device 100. The processor 210 may be implemented as one or more processors. The processor 210 may execute an instruction or a command stored in a memory to perform a certain operation.

The camera 220 photoelectrically converts incident light to generate an electrical image signal. The camera 220 may be integrally formed with or detachably provided from the robot device 100. The camera 220 is disposed above or in front of the robot device 100 so as to photograph the front of the robot device 100. The camera 220 includes at least one lens and an image sensor. The camera 220 transmits an image signal to the processor 210. A plurality of cameras 220 may be disposed in the robot device 100.

The communication interface 230 may wirelessly communicate with an external device. The communication interface 230 may perform short-range communication, and may use, for example, Bluetooth, Bluetooth Low Energy (BLE), Near Field Communication, Wi-Fi (WLAN), Zigbee, Infrared Data Association (IrDA) communication, Wi-Fi Direct (WFD), ultrawideband (UWB), Ant+ communication, etc. For another example, the communication interface 230 may use mobile communication, and transmit or receive a wireless signal to or from at least one of a base station, an external terminal, or a server, on a mobile communication network.

The communication interface 230 communicates with the server 112. The communication interface 230 may establish communication with the server 112 under the control of the processor 210. The communication interface 230 may transmit an input image to the server 112 and receive an object recognition result from the server 112.

Also, the communication interface 230 may communicate with other external devices through short-range communication. For example, the communication interface 230 may communicate with a smart phone, a wearable device, or a home appliance. According to an embodiment of the disclosure, the communication interface 230 may communicate with other external devices through an external server. According to another embodiment of the disclosure, the communication interface 230 may directly communicate with other external devices using short-range communication. For example, the communication interface 230 may directly communicate with a smart phone, a wearable device, or other home appliances by using BLE or WFD.

The moving assembly 240 moves the robot device 100. The moving assembly 240 may be disposed on the lower surface of the robot device 100 to move the robot device 100 forward and backward, and rotate the robot device 100. The moving assembly 240 may include a pair of wheels respectively disposed on left and right edges with respect to the central area of a main body of the robot device 100. In addition, the moving assembly 240 may include a wheel motor that applies a moving force to each wheel, and a caster wheel that is installed in front of the main body and rotates according to a state of a floor surface on which the robot device 100 moves to change an angle. The pair of wheels may be symmetrically disposed on a main body of the robot device 100.

The processor 210 controls the driving of the robot device 100 by controlling the moving assembly 240. The processor 210 sets a driving path of the robot device 100 and drives the moving assembly 240 to move the robot device 100 along the driving path. To this end, the processor 210 generates a driving signal for controlling the moving assembly 240 and outputs the driving signal to the moving assembly 240. The moving assembly 240 drives each component of the moving assembly 240 based on the driving signal output from the processor 210.

The processor 210 receives an image signal input from the camera 220 and processes the image signal to generate an input image. The input image corresponds to a continuously input image stream and may include a plurality of frames. The robot device 100 may include a memory and store an input image in the memory. The processor 210 generates an input image in a form required by the cloud machine learning model 110 or the on-device machine learning model 120. The robot device 100 generates an input image in the form required by the cloud machine learning model 110 in a first mode, and generates an input image in the form required by the on-device machine learning model 120 in a second mode.

Also, the processor 210 detects a person in a driving area. The processor 210 detects a person by using various methods.

According to an embodiment of the disclosure, the processor 210 detects a person by using an output of a machine learning model. The processor 210 uses an output of the cloud machine learning model 110 or the on-device machine learning model 120 to detect a person. The cloud machine learning model 110 and the on-device machine learning model 120 each receive an input image and output object type information and object area information. In the processor 210, the object type information corresponds to one of types of predefined objects. The types of predefined objects may include, for example, a person, table legs, a cable, excrement of animal, a home appliance, an obstacle, etc. The processor 210 detects a person when the object type information output from the cloud machine learning model 110 or the on-device machine learning model 120 corresponds to the person.

According to another embodiment of the disclosure, the processor 210 detects a person by using a separate algorithm for detecting a person. For example, the processor 210 inputs an input image to a person recognition algorithm for recognizing a person, and detects the person by using an output of the person recognition algorithm.

According to another embodiment of the disclosure, the robot device 100 includes a separate sensor, and the processor 210 detects a person by using an output value of the sensor. For example, the robot device 100 may include an infrared sensor and detect a person by using an output of the infrared sensor.

According to another embodiment of the disclosure, the robot device 100 detects a person by receiving person detection information from an external device. The external device may correspond to, for example, a smart phone, a smart home system, a home appliance, or a wearable device. The robot device 100 may receive information that a person is present at home from the external device.

The processor 210 detects a person and determines whether the person is present within the driving area. When the person is detected in the driving area, the processor 210 determines that the person is present in the driving area. Also, the processor 210 detects a person in the entire driving area, and determines that no person is present in the driving area when no person is detected in the entire driving area.

When it is determined that no person is present within the driving area, the processor 210 operates in the first mode. The processor 210 transmits the input image to the server 112 in the first mode and requests object recognition from the server 112. To this end, the processor 210 may process the input image in the form required by the cloud machine learning model 110 of the server 112 and transmit the input image. In addition, the processor 210 may generate an object recognition request requesting an object recognition result of the cloud machine learning model 110 from the server 112 and transmit the object recognition request together with the input image. The object recognition request may include identification information, authentication information, a MAC address, protocol information, etc. of the robot device 100. Also, the processor 210 obtains the object recognition result from the server 112.

When it is determined that a person is preset within the driving area, the processor 210 operates in the second mode. The processor 210 processes the input image in the form required by the on-device machine learning model 120. Also, the processor 210 inputs the input image to the on-device machine learning model 120 in the second mode. The processor 210 obtains object type information and object domain information from the on-device machine learning model 120.

The on-device machine learning model 120 is performed by the processor 210 or by a separate neural processing unit (NPU). The on-device machine learning model 120 may be a lightweight model compared to the cloud machine learning model 110. Also, according to an embodiment of the disclosure, the number of object types recognized by the on-device machine learning model 120 may be equal to or less than the number of object types recognized by the cloud machine learning model 110.

The processor 210 controls driving of the robot device 100 by using the object recognition result output from the cloud machine learning model 110 or the on-device machine learning model 120. The processor 210 recognizes the driving area by using the object recognition result, and detects obstacles in the driving area. The processor 210 drives in the driving area while avoiding obstacles. For example, when the robot device 100 is implemented as a cleaning robot, the processor 210 sets a driving path so as to pass all empty spaces on the floor within the driving area while avoiding obstacles. When the robot device 100 is implemented as a care robot, the processor 210 sets a target location of the robot device 100 and sets an optimal path to the target location. When finding an obstacle while driving along the optimal path, the care robot drives while avoiding the obstacle.

The processor 210 may recognize a predefined object type as an obstacle. For example, the processor 210 may recognize, as an obstacle, a table leg, an excrement of animal, an electric wire, or an object of a volume greater than or equal to a certain size disposed on the floor, among object types recognized by the cloud machine learning model 110 or the on-device machine learning model 120. The processor 210 photographs the front while driving, recognizes obstacles in real time, and controls the driving path to avoid the obstacles.

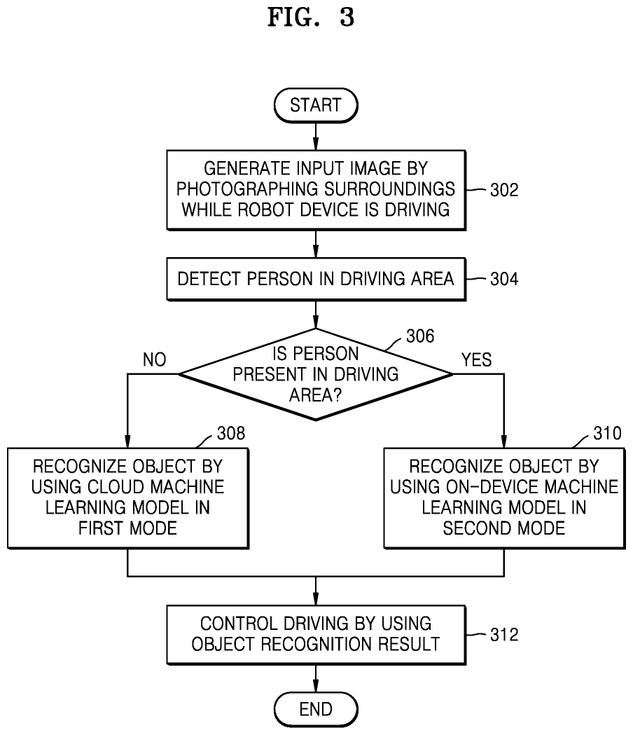

FIG. 3 is a diagram illustrating a method of controlling a robot device according to an embodiment of the disclosure.

The method of controlling the robot device 100 may be performed by various types of robot device 100 including a camera and a processor and capable of driving. Also, the method of controlling the robot device 100 may be performed by an electronic device that controls the robot device 100 while communicating with the robot device 100 capable of driving. For example, a smart phone, a wearable device, a mobile device, a home appliance, etc. communicating with the robot device 100 may control the robot device 100 by performing the method of controlling the robot device 100. In the disclosure, an embodiment in which the robot device 100 described in the disclosure performs the method of controlling the robot device 100 is described, but the embodiment of the disclosure is not limited thereto.

The robot device 100 generates an input image by photographing surroundings while the robot device 100 is driving (302). The robot device 100 may photograph the front and surroundings by using the camera 220. The camera 220 may generate an image signal and output the image signal to the processor 210, and the processor 210 may generate an input image by using the image signal.

Next, the robot device 100 detects a person in a driving area (304). The robot device 100 may detect the person in various ways. For example, the robot device 100 may use various methods such as a method of using an output of a machine learning model, a method of recognizing a person from an input image by using a separate algorithm, a method of using a sensor provided in the robot device, a method of using information received from an external device, etc.

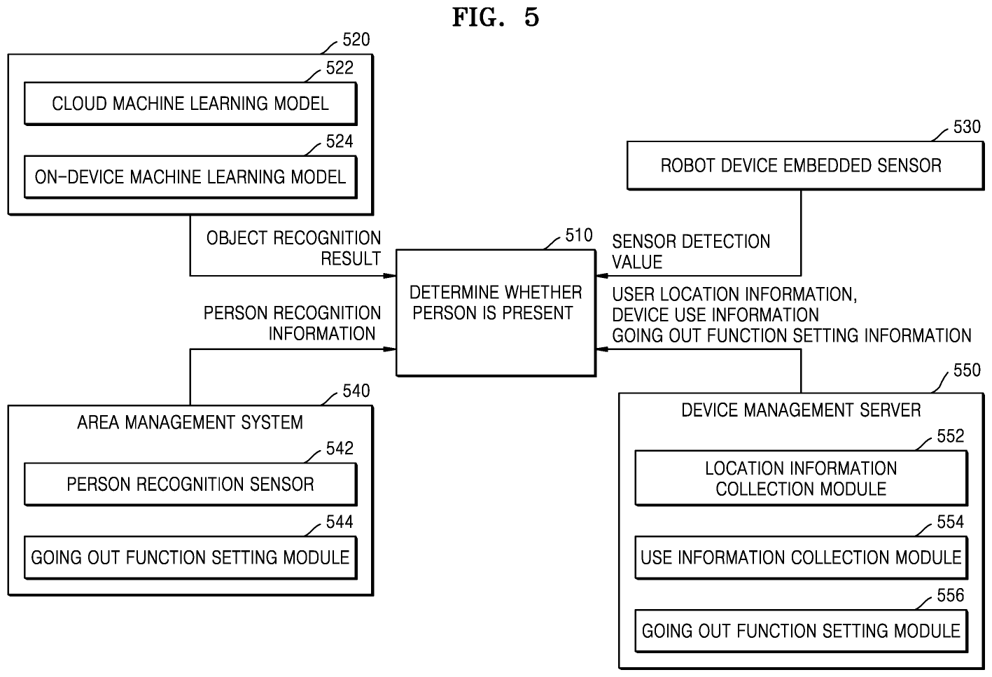

Next, the robot device 100 determines whether the person is present in the driving area (306). A process of determining whether a person is present is described in detail with reference to FIG. 5.

When it is determined that no person is present in the driving area (306), the robot device 100 recognizes an object by using the cloud machine learning model 110 in a first mode (308). The robot device 100 transmits the input image to the server 112 in the first mode and requests object recognition from the server 112. The server 112 inputs the input image received from the robot device 100 to the cloud machine learning model 110. The cloud machine learning model 110 receives the input image and outputs object type information and object area information. The server 112 transmits object recognition results including object type information and object area information to the robot device 100.

When it is determined that the person is present in the driving area (306), the robot device 100 recognizes the object by using the on-device machine learning model 120 in a second mode (310). The robot device 100 inputs the input image to the on-device machine learning model 120 in the second mode. The on-device machine learning model 120 receives the input image and outputs the object type and the object area information.

The robot device 100 controls driving of the robot device 100 by using an object recognition result obtained from the cloud machine learning model 110 or the on-device machine learning model 120 (312). The robot device 100 sets a driving path using the object recognition result and controls the moving assembly 240 to move the robot device 100 along the driving path.

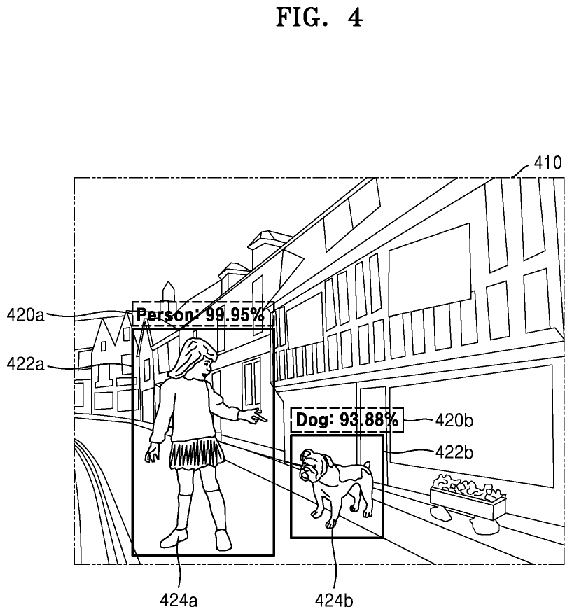

FIG. 4 is a diagram illustrating an output of a machine learning model according to an embodiment of the disclosure.

According to an embodiment of the disclosure, the cloud machine learning model 110 and the on-device machine learning model 120 each receive an input image and output object type information and object area information. The cloud machine learning model 110 and the on-device machine learning model 120 may be implemented as various types of machine learning models for object recognition. For example, the cloud machine learning model 110 and the on-device machine learning model 120 may use a YoLo machine learning model.

The cloud machine learning model 110 and the on-device machine learning model 120 may have a deep neural network (DNN) structure including a plurality of layers. In addition, the cloud machine learning model 110 and the on-device machine learning model 120 may be implemented as a CNN structure or an RNN structure, or a combination thereof. The cloud machine learning model 110 and the on-device machine learning model 120 each include an input layer, a plurality of hidden layers, and an output layer.

The input layer receives an input vector generated from an input image and generates at least one input feature map. The at least one input feature map is input to the hidden layer and processed. The hidden layer is previously trained by a certain machine learning algorithm and generated. The hidden layer receives the at least one feature map and generates at least one output feature map by performing activation processing, pooling processing, linear processing, convolution processing, etc. The output layer converts the output feature map into an output vector and outputs the output vector. The cloud machine learning model 110 and the on-device machine learning model 120 obtain the object type information and the object area information from the output vector output from the output layer.

The cloud machine learning model 110 and the on-device machine learning model 120 may recognize a plurality of objects 424a and 424b. The maximum number of recognizable objects in the cloud machine learning model 110 and the on-device machine learning model 120 may be previously set.

The maximum number of recognizable objects, object types, and object recognition accuracy in the cloud machine learning model 110 may be greater than those of the on-device machine learning model 120. Because the robot device 100 has less computing power and resources than the server 112, the on-device machine learning model 120 may be implemented as a model that is lighter than the cloud machine learning model 110. For example, the on-device machine learning model 120 may be implemented by applying at least one bypass path between layers of the cloud machine learning model 110. A bypass path is a path through which an output is directly transferred from one layer to another layer. The bypass path is used to skip a certain layer and process data. When the bypass path is applied, processing of some layers is skipped, which reduces the throughput of a machine learning model and shortens the processing time.

According to an embodiment of the disclosure, as shown in FIG. 4, object type information 420a and 420b and object area information 422a and 422b may be generated. The cloud machine learning model 110 and the on-device machine learning model 120 recognize one or more objects 424a and 424b from an input image 410. Types of objects to be recognized may be predefined, and for example, types such as person, furniture, furniture legs, excrement of animal, etc. may be predefined.

The object type information 420a and 420b indicate object types (person and dog). According to an embodiment of the disclosure, the object type information 420a and 420b may further include a probability value indicating a probability of being a corresponding object. For example, in the example of FIG. 4, it is output that the probability that the first object 424a is a person is 99.95% and the probability that the second object 424b is a dog is 99.88%.

The object area information 422a and 422b respectively indicate areas where the objects 424a and 424b are detected. The object area information 422a and 422b correspond to boxes defining the areas where the objects 424a and 424b are detected, as shown in FIG. 4. The object area information 422a and 422b may indicate, for example, one vertex of boxes defining the areas where the objects 424a and 424b are detected and width and breadth information of the areas.

FIG. 5 is a diagram illustrating a process of determining whether a person is present according to an embodiment of the disclosure.

According to an embodiment of the disclosure, the robot device 100 may determine whether the person is present in a driving area by using various information (510). Various combinations of methods of determining whether the person is present described in FIG. 5 may be applied to the robot device 100. In addition, the robot device 100 may determine whether the person is present based on information input first among various information. The processor 210 of the robot device 100 may determine whether the person is present in the driving area based on at least one of an object recognition result of the machine learning model 520, a sensor detection value of a robot device embedded sensor 530, information of an area management system 540, or information of a device management server 550 or a combination thereof.

The processor 210 may receive the object recognition result from the machine learning model 520, detect the person based on the object recognition result, and determine whether the person is present. The processor 210 determines whether the person is present among object type information included in the object recognition result. When the person is present in the object type information, the processor 210 determines that the person is present.

The processor 210 may receive the sensor detection value from the robot device embedded sensor 530, and determine whether the person is present based on the sensor detection value. The robot device 100 may include a separate sensor other than the camera 220. The sensor may correspond to, for example, an infrared sensor. The processor 210 may receive a sensor detection value of the infrared sensor and generate an infrared image. The processor 210 may determine that the person is present when recognizing an object having a temperature range corresponding to body temperature and having a person shape in the infrared image.

The processor 210 may receive person recognition information or going out function setting information from the area management system 540 and determine whether the person is present based on the received information. The area management system 540 is a system for managing a certain area, and may correspond to, for example, a smart home system, a home network system, a building management system, a security system, or a store management system. The area management system 540 may be disposed in an area or implemented in the form of a cloud server. The robot device 100 may receive information from the area management system 540 that manages an area corresponding to the driving area of the robot device 100.

The area management system 540 may include a person recognition sensor 542 that recognizes a person in the area. The person recognition sensor 542 may include a motion sensor detecting motion, a security camera, etc. The area management system 540 may determine that a person is present when the motion sensor detects motion corresponding to motion of the person. In addition, the area management system 540 may obtain an image of the area photographed by the security camera and detect a person in the obtained image. As described above, when the area management system 540 detects a person by using the motion sensor or the security camera, the area management system 540 may generate person recognition information and transmit the person recognition information to the robot device 100. When receiving person recognition information from the area management system 540, the processor 210 determines whether the area where the person is detected by the area management system 540 corresponds to the driving area of the robot device 100. The processor 210 determines that the person is present in the driving area when the area where the person is detected by the area management system 540 corresponds to the driving area.

In addition, the area management system 540 may include a going out function setting module 544 providing a going out function. When a user sets a system to a going out mode, the going out function setting module 544 may determine that no person is present in the area and perform a function of the system. For example, in the smart home system, the user may set the going out mode when going out. As another example, in the security system, the user may set the going out mode when no person is present in the area. When the going out mode is set, the area management system 540 transmits the going out function setting information to the robot device 100. When receiving the going out function setting information from the area management system 540, the processor 210 determines whether the area where the going out mode is set corresponds to the driving area. When the area where the going out mode is set corresponds to the driving area, the processor 210 determines that no person is present in the driving area.

The processor 210 may receive user location information or the going out function setting information from the device management server 550 and determine whether a person is present by using the received information. The device management server 550 is a server that manages one or more electronic devices including the robot device 100. The device management server 550 manages one or more electronic devices registered in a user account. The one or more electronic devices are registered in the device management server 550 after performing authentication using user account information. The one or more electronic devices may include, for example, a smart phone, a wearable device, a refrigerator, a washing machine, an air conditioner, a cleaning robot, a humidifier, or an air purifier.

The device management server 550 may include a location information collection module 552 that collects location information from a mobile device (e.g., a smart phone or a wearable device) among registered electronic devices. The location information collection module 552 collects location information of the user by collecting the location information of the mobile device. The device management server 550 may transmit the user location information to the robot device 100. The processor 210 may use the user location information received from the device management server 550 to determine whether the user is present in the driving area. When it is determined that the user is present in the driving area, the processor 210 may determine that a person is present in the driving area.

The device management server 550 may include a use information collection module 554 that collects use information of registered electronic devices. The use information collection module 554 collects use information of home electronic devices. For example, the use information collection module 554 may determine that the user is present at home when an event in which the user manipulates a home appliance such as a refrigerator, a washing machine, an air conditioner, or an air purifier at home occurs. For example, when detecting a user opening and closing a refrigerator door, the refrigerator determines that an event in which the user manipulates the refrigerator has occurred, and generates user location information indicating that the user is present at home. As another example, when detecting a user manipulating a button of the washing machine or opening and closing a door of the washing machine, the washing machine determines that an event in which the user manipulates the washing machine has occurred and generates user location information indicating that the user is present at home. The device management server 550 transmits the user location information to the robot device 100 when the user location information indicating that the user is present at home is generated by the use information collection module 554. When receiving the user location information indicating that the user is present at home from the device management server 550, the robot device 100 determines that the user is present in the driving area.

As another example, the user information collection module 554 generates device use information indicating that the user manipulated a home appliance at home when an event in which the user manipulates the home appliance at home occurs, and the device management server 550 transmits the device use information to the robot device 100. When the robot device 100 receives the device use information, the processor 210 determines whether a used device is an electronic device within the driving area. When the used device is the electronic device within the driving area, the processor 210 determines that a person is present in the driving area.

In addition, the device management server 550 may include a going out function setting module 556 that provides a going out function when the going out mode is set by at least one of the electronic devices registered in the device management server 550. When the going out mode is set by the at least one electronic device, the going out function setting module 556 may change the registered electronic devices to the going out mode. In the going out mode, the device management server 550 may perform a certain operation, such as changing an electronic device at home to a power saving mode or executing a security function. When the going out mode is set, the device management server 550 transmits going out function setting information including information indicating that the going out mode is set to the robot device 100. When the robot device 100 receives the going out function setting information, the processor 210 may determine whether an area where the going out mode is set corresponds to the driving area. When the area where the going out mode is set corresponds to the driving area, the processor 210 determines that no person is present in the driving area.

According to an embodiment of the disclosure, the cloud machine learning model 110 may be performed within the device management server 550. For example, a cloud server in which the cloud machine learning model 110 operates may be the same server as the device management server 550. As another example, the cloud machine learning model 110 may be performed in the server 112 separate from the device management server 550.

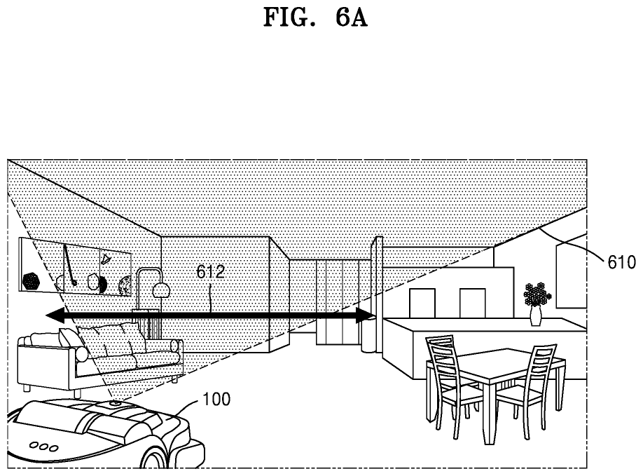

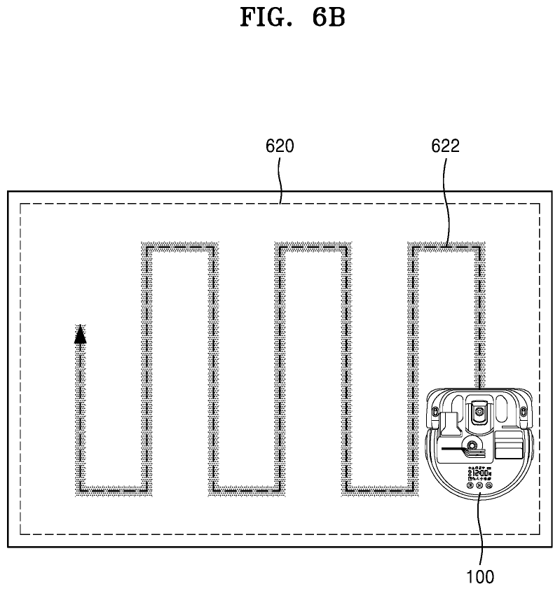

FIGS. 6A and 6B are diagrams illustrating an operation of a robot device in a patrol mode performed according to an embodiment of the disclosure.

According to an embodiment of the disclosure, when starting driving in a driving area, the robot device 100 may perform the patrol mode to determine whether a person is present in the driving area. In the patrol mode, the robot device 100 determines whether the person is present in the entire driving area. When the person is detected while scanning the entire driving area, the robot device 100 determines that the person is present in the driving area. When no person is detected until the entire driving area is completely scanned, the robot device 100 determines that no person is present in the driving area. Scanning of the driving area may be performed by using the camera 220 or a separate sensor provided in the robot device 100. An output of the camera 220 and an output of the sensor may be also used together.

According to an embodiment of the disclosure, as shown in FIG. 6A, the robot device 100 photographs the entire driving area by using the camera 220 (610). In order to photograph the entire driving area, the robot device 100 may move to an edge of the driving area, photograph the driving area with a field of view (FOV) of an angle of view (AOV) as wide as possible, and detect a person in a captured input image. The robot device 100 may split the driving area into certain areas and photograph the certain areas with a wide AOV multiple times. For example, the robot device 100 may split the driving area into a left area and a right area, photograph the left area at the center of the driving area, and then photograph the right area.

The robot device 100 may move the AOV of the camera 220 to scan the entire driving area (612). For example, the robot device 100 may move the AOV of the camera 220 by rotating a main body of the robot device 100 left and right. As another example, when the camera 220 supports movement of the AOV, the robot device 100 may scan the driving area by moving the AOV of the camera 220 itself.

As another example, the robot device 100 scans the entire driving area by using a sensor. For example, the robot device 100 may scan the entire driving area by using an infrared sensor. A scanning operation using the infrared sensor is similar to a scanning operation of the camera 220 described above. As another example, the robot device 100 may scan the driving area by using a lidar sensor or a 3D sensor.

According to another embodiment of the disclosure, as shown in FIG. 6B, the robot device 100 may scan a driving area 620 while moving to a certain driving path 622 along the driving area 620, and detect a person. For example, the robot device 100 may scan the entire driving area 620 while driving the driving area 620 in a zigzag shape. According to an embodiment of the disclosure, the driving path 622 in the zigzag shape in the patrol mode may be set at a wider space than the driving path 622 in the zigzag shape in a normal mode. Because the driving path 622 in the zigzag shape in the patrol mode is intended to scan the entire driving area, photographing may be performed at a wider space than in the normal mode such as a cleaning mode. The driving path 622 in the patrol mode is set in the zigzag shape at a space as wide as possible so that the entire driving area may be scanned within a short period of time.

As another example, the robot device 100 scans the entire driving area while moving along the certain driving path 622 by using a sensor. For example, the robot device 100 may drive along the driving path 622 and scan the entire driving area while capturing an infrared image by using an infrared sensor. A scanning operation using the infrared sensor is similar to the scanning operation of the camera 220 described above.

The shape of the driving path 622 may be set in various shapes other than the zigzag shape.

The robot device 100 sets an operation mode to a first mode or a second mode when it is determined whether a person is present in the driving area in the patrol mode. When it is determined that no person is present in the driving area, the processor 210 operates in the first mode using the cloud machine learning model 110. When it is determined that the person is present in the driving area, the processor 210 operates in the second mode using the on-device machine learning model 120.

According to an embodiment of the disclosure, the robot device 100 may determine whether a person is present in the driving area within a short time in the patrol mode when starting driving in the driving area, and thus, there are advantages of not excessively increasing the operation preparation time of the robot device 100 while providing a function of protecting user privacy.

When the robot device 100 receives the person recognition information or the going out function setting information from the area management system 540 and already determines whether a person is present in the driving area upon starting driving in the driving area, the robot device 100 may directly set the operation mode to the first mode or the second mode without performing the patrol mode. In addition, when the robot device 100 receives the user location information, the device use information, or the going out function setting information from the device management server 550 and already determines whether a person is present in the driving area upon starting driving in the driving area, the robot device 100 may directly set the operation mode to the first mode or the second mode without performing the patrol mode.

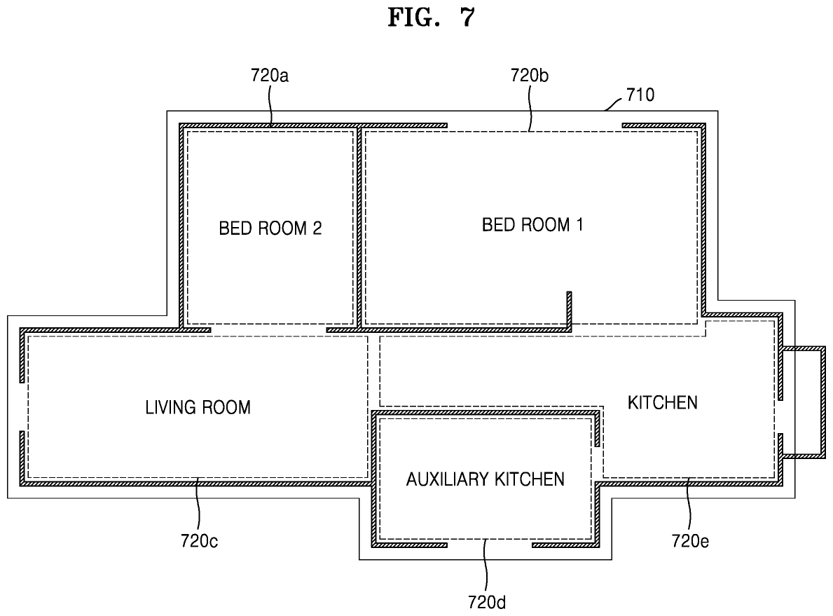

FIG. 7 is a diagram illustrating a driving area of a robot device according to an embodiment of the disclosure.

According to an embodiment of the disclosure, the driving area of the robot device 100 may correspond to an indoor area distinguished by walls or doors. In the disclosure, an embodiment in which the driving area is an area at home corresponding to a normal home is mainly described. However, embodiments of the disclosure are not limited to these embodiments, and the driving area may correspond to various indoor or outdoor areas.

A driving area 710 may include one or more sub driving areas 720a, 720b, 720c, 720d, and 720e. The sub driving areas 720a, 720b, 720c, 720d, and 720e may correspond to rooms, a living room, kitchens, etc. Boundaries of the sub driving areas 720a, 720b, 720c, 720d, and 720e may be determined by walls or doors. A driving algorithm of the robot device 100 may scan the driving area 710 and detect walls and doors to define the driving area 710 and the sub driving areas 720a, 720b, 720c, 720d, and 720e. Also, according to an embodiment of the disclosure, the robot device 100 may set the driving area 710 and the one or more sub driving areas 720a, 720b, 720c, 720d, and 720e according to a user input. The robot device 100 may also set a driving prohibition area according to a user input.

According to an embodiment of the disclosure, the robot device 100 may determine whether a person is present in the entire driving area 710 and set an operation mode to a first mode or a second mode. In this case, the robot device 100 may equally apply one of the first mode and the second mode to the one or more sub driving areas 720a, 720b, 720c, 720d, and 720e. In this case, the robot device 100 may perform a set operation (e.g. cleaning) without an operation of determining whether a person is present when moving between the sub driving areas 720a, 720b, 720c, 720d, and 720e, and determining a mode.

According to another embodiment of the disclosure, the robot device 100 may determine whether a person is present in each of the sub driving areas 720a, 720b, 720c, 720d, and 720e, and set the operation mode to the first mode or the second mode. When starting driving in each of the sub driving areas 720a, 720b, 720c, 720d, and 720e, the robot device 100 may determine whether a person is present in each of the sub driving areas 720a, 720b, 720c, 720d, and 720e. For example, when starting cleaning the bedroom 2 720a, the robot device 100 determines whether a person is present in the bedroom 2 720a, and sets the operation mode in the bedroom 2 720a to the first mode or the second mode. In addition, when finishing cleaning the bedroom 2 720a and moving to the living room 720c to clean, the robot device 100 determines whether a person is present in the living room 720c, and sets the operation mode in the living room 720c to the first mode or the second mode. When no person is present in the bedroom 2 720a and a person is present in the living room 720c, the robot device 100 may operate in the first mode in the bedroom 2 720a and operate in the second mode in the living room 720c.

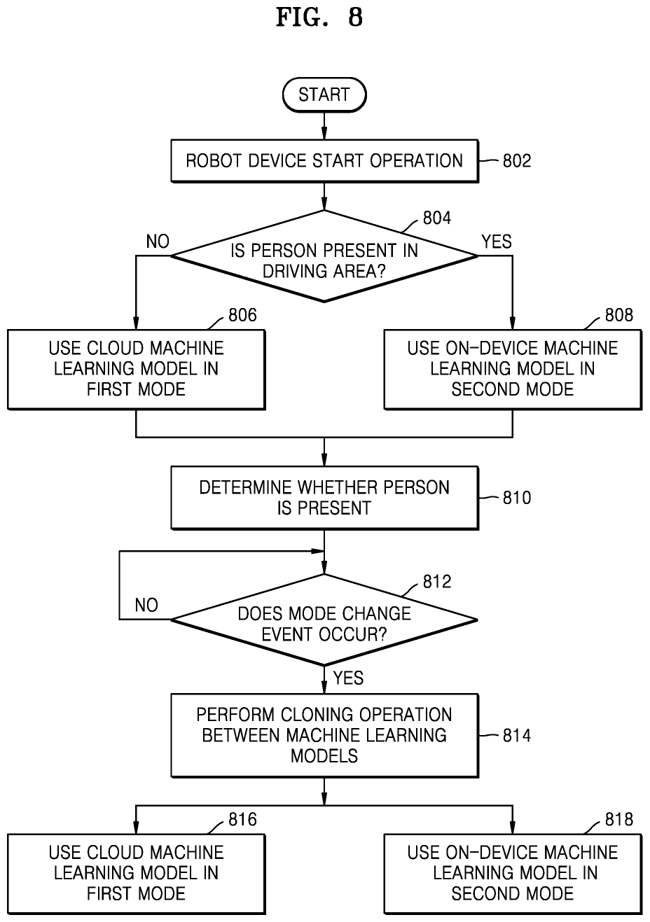

FIG. 8 is a diagram illustrating a control operation of a machine learning model of a robot device according to an embodiment of the disclosure.

According to an embodiment of the disclosure, the robot device 100 detects a person in a driving area and changes an operation mode according to a result of determining whether the person is present. At this time, a cloning operation may be performed between the cloud machine learning model 110 used in a first mode and the on-device machine learning model 120 used in a second mode. The cloning operation is an operation of synchronizing between two machine learning models, and is an operation of reflecting a result of learning performed during an operation of the robot device 100 to another machine learning model.

According to an embodiment of the disclosure, the robot device 100 starts an operation (802) and determines whether a person is present in the driving area (804).

According to an embodiment of the disclosure, the robot device 100 starts an operation (802), and may operate in a previously determined default mode when the operation mode has not been determined. The default mode may be the first mode or the second mode.

When no person is present in the driving area, the robot device 100 sets the operation mode of the robot device 100 to the first mode and recognizes an object from an input image by using the cloud machine learning model 110 (806). When the person is present in the driving area, the robot device 100 sets the operation mode of the robot device 100 to the second mode and recognizes the object from the input image by using the on-device machine learning model 120 (808).

The robot device 100 sets a mode and continuously determines whether the person is present in the driving area while driving in the driving area (810). Even when the mode is completely set, the robot device 100 continuously determines whether the person is present even during the operation because a state regarding whether the person is present may be changed while driving. When a mode change event occurs during the operation (812), the robot device 100 performs a preparation operation for a mode change.

Before changing the mode, the robot device 100 performs the cloning operation between machine learning models. The robot device 100 may additionally train a machine learning model while collecting input images while driving. The cloud machine learning model 110 and the on-device machine learning model 120 may perform additional learning by reflecting an environment of the driving area by using the input image provided from the robot device 100. For example, assuming that the cloud machine learning model 110 or the on-device machine learning model 120 determines that there is no obstacle in the input image, and the robot device 100 determines that there is no obstacle and moves forward, but collides with an obstacle. In this case, the robot device 100 may generate feedback information indicating that there was the obstacle in front and transmit the feedback information to a block performing training of the cloud machine learning model 110 or the on-device machine learning model 120. When the feedback information is generated, the cloud machine learning model 110 or the on-device machine learning model 120 that processed the input image may be re-trained. That is, when the feedback information is generated, the cloud machine learning model 110 is re-trained in the first mode, and the on-device machine learning model 120 is re-trained in the second mode. As described above, the cloud machine learning model 110 and the on-device machine learning model 120 may be re-trained while driving, and parameter values of the cloud machine learning model 110 and the on-device machine learning model 120 may be modified according to re-training results.

According to an embodiment of the disclosure, when the mode change event occurs and the mode is changed, and when re-training is performed on a machine learning model currently used before changing the mode, the cloning operation of reflecting a re-training result of the machine learning model currently used to another machine learning model is performed (814). For example, when re-training of the cloud machine learning model 110 is performed during the operation in the first mode and the mode change event occurs (812), the cloning operation of reflecting a parameter value modified by re-training of the cloud machine learning model 110 to the on-device machine learning model 120 is performed. As another example, when re-training of the on-device machine learning model 120 is performed during the operation in the second mode and the mode change event occurs (812), the cloning operation of reflecting a parameter value modified by re-training of the on-device machine learning model 120 to the cloud machine learning model 110 is performed.

The cloud machine learning model 110 and the on-device machine learning model 120 include a plurality of layers and a plurality of nodes. When data is processed through the plurality of layers and the plurality of nodes, a certain weight is applied and an output value of each node is transferred. In addition, various parameters applied to an operation performed in each layer are present. A value of a parameter including such a weight is determined through machine learning. When re-learning is performed on a machine learning model, a parameter value of the machine learning model is changed. A device that performs a machine learning model may include a parameter management module that performs an operation of applying such a parameter value to each layer and node. When re-training of the machine learning model is performed according to an embodiment of the disclosure, the parameter management module updates parameter values and generates re-training information indicating that parameter values have been updated. When the mode change event occurs (812), the robot device 100 determines whether the re-training information indicating that parameter values have been updated is present in the parameter management module of the device performing the operation of the machine learning model in a current mode. When the re-training information is present, the robot device 100 performs the cloning operation between machine learning models before changing the mode.

As described above, the on-device machine learning model 120 may be a model obtained by applying at least one bypass path to the cloud machine learning model 110. When performing the cloning operation, the robot device 100 synchronizes the parameter values in two machine learning models. When the first mode is changed to the second mode, the robot device 100 receives re-training information and a parameter value set from the server 112, and reflects the parameter value set received from the server 112 to a parameter value set of the on-device machine learning model 120. When the second mode is changed to the first mode, the robot device 100 transmits re-training information and a parameter value set of the on-device machine learning model 120 to the server 112. The server 112 reflects the parameter value set received from the robot device 100 to a parameter value set of the cloud machine learning model 110.

When the cloning operation between machine learning models is performed (814), the robot device 100 changes the operation mode of the robot device 100 to the first mode (816) or to the second mode (818) based on the mode change event. When the mode change event occurs, and there is no history of re-training performed on the machine learning model currently used, the mode may be changed immediately without performing the cloning operation.

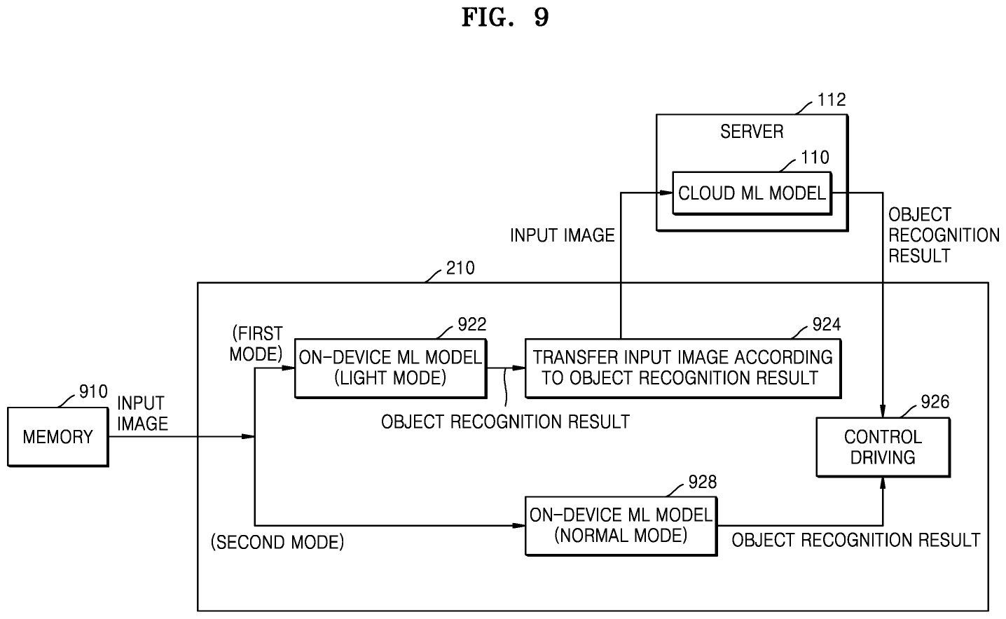

FIG. 9 is a diagram illustrating an operation of a robot device according to an embodiment of the disclosure.

According to an embodiment of the disclosure, before transmitting an input image to the server 112 in a first mode, the robot device 100 may determine whether a person is present in the input image, and when the person is present, may not transmit the input image. To this end, the processor 210 performs a process of recognizing the person from the input image before transmitting the input image to the server 112.

According to an embodiment of the disclosure, the robot device 100 may use the on-device machine learning model 120 to recognize the person from the input image in the first mode. In the first mode, the robot device 100 may input the input image to the on-device machine learning model 120, and then, when no person is detected from an object recognition result of the on-device machine learning model 120, transmit the input image to the server 112.

According to an embodiment of the disclosure, when using the on-device machine learning model 120 in the first mode, the robot device 100 may set a mode of the on-device machine learning model 120 to a light mode. An on-device machine learning model 922 in the light mode is a lightweight model of the on-device machine learning model 922, and is a model obtained by applying at least one bypass path to the on-device machine learning model 120. The on-device machine learning model 922 in the light mode may operate with accuracy of a certain criterion or higher only with respect to person recognition, without considering the recognition accuracy of an object other than the person. The on-device machine learning model 120 may operate in the light mode in a first mode and in a normal mode in a second mode.

When an input image is input from a memory 910, the processor 210 transfers the input image according to a current mode. When the current mode is the first mode, the input image is input to the on-device machine learning model 922 in the light mode. The processor 210 sets the on-device machine learning model 922 to the lite mode in the first mode. The on-device machine learning model 922 in lite mode outputs an object recognition result. The processor 210 transfers the input image according to the object recognition result (924).

When a person is detected in the input image based on the object recognition result of the on-device machine learning model 922 in the light mode, the processor 210 does not transmit the input image to the server 112. When it is determined that a person is present based on the object recognition result, the processor 210 may change the mode of the robot device 100 to the second mode. The processor 201 transmits the input image to the server 112 when no person is detected in the input image based on the object recognition result of the on-device machine learning model 922 in the light mode.

The processor 210 sets the on-device machine learning model to the normal mode in the second mode, and inputs the input image to an on-device machine learning model 928 in the normal mode.

The processor 210 performs a driving control operation 926 by using an object recognition result output from the cloud machine learning model 110 or the on-device machine learning model 928 in the normal mode.

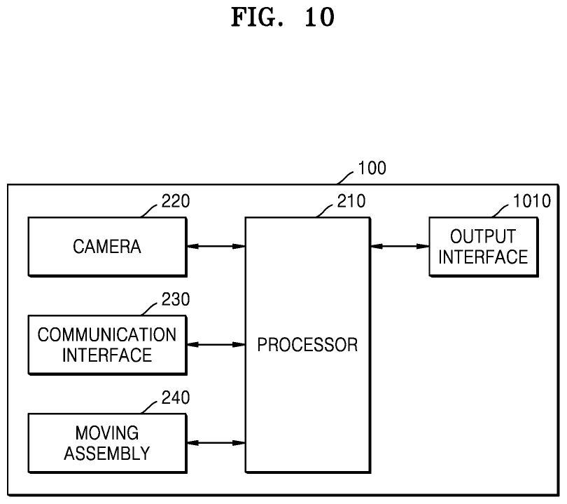

FIG. 10 is a diagram illustrating a configuration of a robot device according to an embodiment of the disclosure.

The robot device 100 according to an embodiment of the disclosure may include the processor 210, the camera 220, the communication interface 230, the moving assembly 240, and an output interface 1010. The processor 210, the camera 220, the communication interface 230, the moving assembly 240 shown in FIG. 10 correspond to those shown in FIG. 2. Accordingly, in FIG. 10, differences from the embodiment shown in FIG. 2 are mainly described.

The output interface 1010 is an interface that outputs information output through the robot device 100. The output interface 1010 may include various types of devices. For example, the output interface 1010 may include a display, a speaker, or a touch screen.

The robot device 100 may include a display disposed on an upper surface of a main body. The display may display information such as an operation mode, a current state, a notification message, a time, a communication state, and remaining battery information of the robot device 100. The processor 210 generates information to be displayed on the display and outputs the information to the display. The display may be implemented in various ways, and may be implemented in the form of, for example, a liquid crystal display, an organic electroluminescent display, or an electrophoretic display.

The robot device 100 outputs information about an operation mode of a machine learning model through the output interface 1010. The processor 210 may determine whether a person is present in a driving area, and output a mode change recommendation message through the output interface 1010 when an event requiring a mode change occurs according to a determination result. The mode change recommendation message may include information about a recommended mode and a request for confirmation on whether to change the mode.

The robot device 100 may output the mode change recommendation message as visual information or audio information, or a combination thereof. A format for outputting the mode change recommendation message may be previously set. For example, the robot device 100 may include an operation mode such as a normal mode, a silent mode, and a do not disturb mode. The robot device 100 outputs the mode change recommendation message as a combination of the visual information and the audio information in the normal mode. In addition, the robot device 100 outputs the mode change recommendation message as the visual information in the silent mode and the do not disturb mode, and does not output the audio information. The processor 210 may generate visual information or audio information according to the current mode and output the generated visual information or audio information through the output interface 1010.

According to an embodiment of the disclosure, the robot device 100 may change the mode when there is a user selection on the mode change recommendation message, and may not change the mode when the user selection is not input. For example, when the robot device 100 outputs a mode change recommendation message recommending a mode change to the second mode while operating in the first mode, the robot device 100 may change the first mode to the second mode when receiving a user input for selecting the mode change, and may not change the first mode to the second mode when receiving a user input for selecting not to change the mode or when receiving no selection input. In addition, when the robot device 100 outputs a mode change recommendation message recommending a mode change to the first mode while operating in the second mode, the robot device 100 may change the second mode to the first mode when receiving a user input for selecting the mode change, and may not change the second mode to the first mode when receiving a user input for selecting not to change the mode or when receiving no selection input.

According to an embodiment of the disclosure, the robot device 100 may output the mode change recommendation message, change or maintain the mode according to a user input when receiving the user input for selecting a mode change or a mode maintenance within a reference time, and automatically change the mode to a recommended mode when receiving no user input with respect to a mode change request message within the reference time. For example, the robot device 100 outputs the mode change recommendation message, waits for reception of the user input for 30 seconds, and automatically changes the mode to the recommended mode when receiving no user input within 30 seconds.

According to an embodiment of the disclosure, when the robot device 100 recommends the first mode while operating in the second mode, the robot device 100 may be maintained in the second mode without changing the operation mode to the first mode when receiving no user input for selecting the mode change within the reference time. Because the input image is transmitted to the server 112 in the first mode, when there is no user input for selecting the mode change, the operation mode of the robot device 100 may not be changed. When the robot device 100 recommends the second mode while operating in the first mode, the robot device 100 may automatically change the operation mode to the second mode when receiving no user input for selecting the mode change or the maintenance within the reference time. Because a mode change recommendation to the second mode is for protecting user privacy, when the user does not explicitly select to maintain the operation mode in the first mode, the robot device 100 may automatically change the operation mode of the robot device 100 to the second mode for privacy protection.

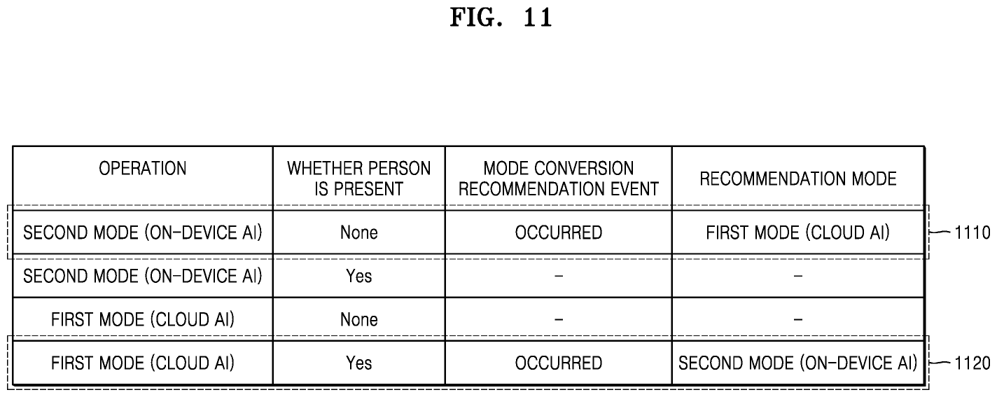

FIG. 11 is a diagram illustrating a condition for determining a mode change and a case where a mode conversion recommendation event occurs according to an embodiment of the disclosure.

According to an embodiment of the disclosure, the processor 210 continuously determines whether a person is present while operating in a first mode or in a second mode. When it is determined that no person is present in a driving area while operating in the second mode, the processor 210 determines that the mode conversion recommendation event recommending a mode conversion to the first mode has occurred (1110). In addition, when it is determined that the person is present in the driving area while operating in the first mode, the processor 210 determines that the mode conversion recommendation event recommending the mode conversion to the second mode has occurred (1120).

According to an embodiment of the disclosure, the processor 210 may perform an operation of outputting a mode change recommendation message when a mode conversion event occurs. When the mode conversion event occurs, the processor 210 generates and outputs the mode change recommendation message based on recommendation mode information.

According to another embodiment of the disclosure, when the mode conversion event occurs, the processor 210 changes an operation mode to a recommended mode after outputting a mode change notification message. The mode change notification message includes a notification message indicating a change to a mode, and does not require a response from a user. According to an embodiment of the disclosure, a user interface menu through which the user may select whether to change the mode may be provided together with the mode change notification message. In this case, a selection input of the user is not necessary. When receiving the user input, the robot device 100 determines whether to change the mode based on the user input, and automatically changes the operation mode to the recommended mode when there is no user input.

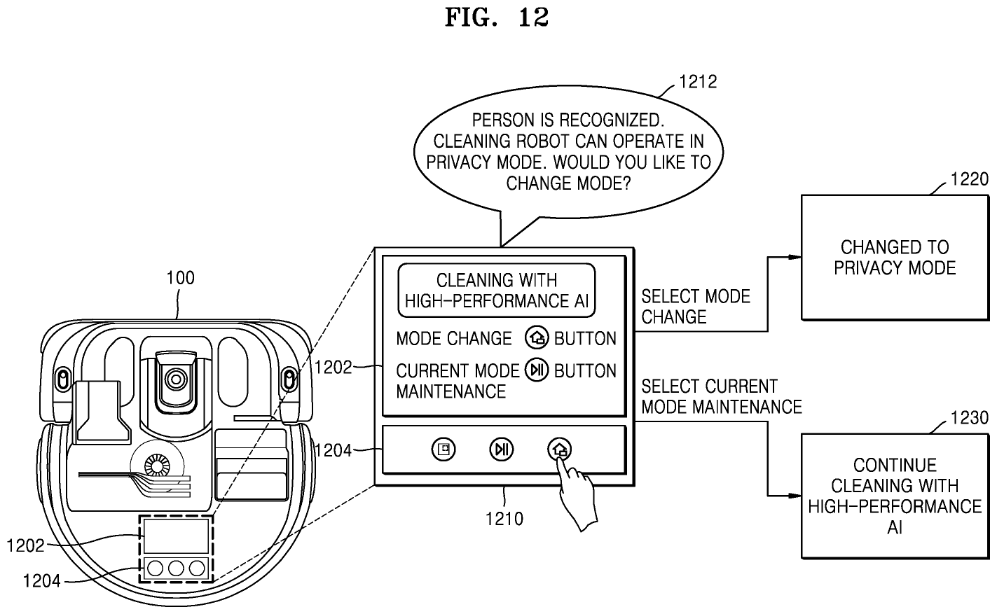

FIG. 12 is a diagram illustrating an operation in which a robot device outputs a mode change recommendation message according to an embodiment of the disclosure.

According to an embodiment of the disclosure, the robot device 100 may include a display 1202 and an input interface 1204 on an upper surface of a main body. The display 1202 displays information about an operating state of the robot device 100. The input interface 1204 includes at least one button and receives a user input. A user may input a desired selection signal by pressing the at least one button. The robot device 100 may display a current mode on the display 1202 and display options selectable by the user through the input interface 1204.

When a person is detected while operating in a first mode, the robot device 100 may generate and output the mode change recommendation message recommending a mode change to a second mode. When a person is detected while operating in the first mode, the processor 210 generates and outputs a mode change recommendation message 1212 in the form of an audio output. A speaker (not shown) provided in the robot device 100 outputs the mode change recommendation message in the form of the audio output.

In addition, when a person is detected while operating in the first mode, the robot device 100 may provide a graphic user interface (GUI) capable of selecting a mode change or a current mode maintenance (1210). The processor 210 provides a GUI view capable of selecting the mode change or the current mode maintenance through the display 1202. The user may input a selection signal for selecting the mode change or the current mode maintenance through the input interface 1204 according to an option guided on the display 1202. While outputting the mode change recommendation message and waiting for a user input, the robot device 100 may stop driving and wait for the user input for a certain time. When receiving no user input for a certain time, the robot device 100 may automatically change or maintain a mode, start driving again, and resume a set operation (e.g., cleaning).

When a user input for selecting the mode change is received, an operation mode of the robot device 100 is changed to the second mode, and a guide message 1220 indicating that the mode has changed is output to at least one of the display 1202 or the speaker. When receiving a user input for selecting the current mode maintenance, the robot device 100 continues to operate in the first mode without changing the mode. In addition, a guide message 1230 indicating that the robot device 100 is operating in the first mode using the cloud machine learning model 110 is output to at least one of the display 1202 or the speaker.

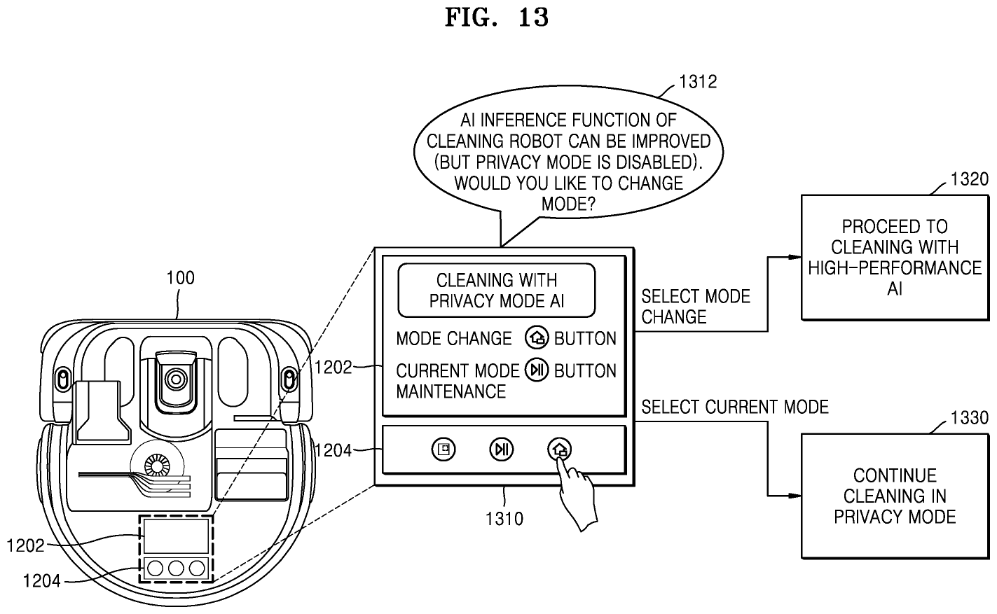

FIG. 13 is a diagram illustrating an operation in which a robot device outputs a mode change recommendation message according to an embodiment of the disclosure.

When it is determined that no person is present in a driving area while operating in a second mode, the robot device 100 may generate and output the mode change recommendation message recommending a mode change to a first mode. When it is determined that no person is present in the driving area while operating in the second mode, the processor 210 generates and outputs a mode change recommendation message 1312 in the form of an audio output. A speaker (not shown) provided in the robot device 100 outputs the mode change recommendation message in the form of the audio output.

In addition, when it is determined that no person is present in the driving area while operating in the second mode, the robot device 100 may provide a GUI capable of selecting a mode change or a current mode maintenance (1310). The processor 210 provides a GUI view capable of selecting the mode change or the current mode maintenance through the display 1202. A user may input a selection signal for selecting the mode change or the current mode maintenance through the input interface 1204 according to an option guided on the display 1202. While outputting the mode change recommendation message and waiting for a user input, the robot device 100 may stop driving and wait for the user input for a certain time. When receiving no user input for a certain time, the robot device 100 may automatically change or maintain a mode, start driving again, and resume a set operation (e.g., cleaning).

When a user input for selecting the mode change is received, an operation mode of the robot device 100 is changed to the first mode, and a guide message 1320 indicating that the mode has changed is output to at least one of the display 1202 or the speaker. When a user input for selecting the current mode maintenance is received, the robot device 100 continues to operate in the second mode without changing the mode. In addition, a guide message 1330 indicating that the robot device 100 is operating in the second mode using an on-device machine learning model is output to at least one of the display 1202 or the speaker.

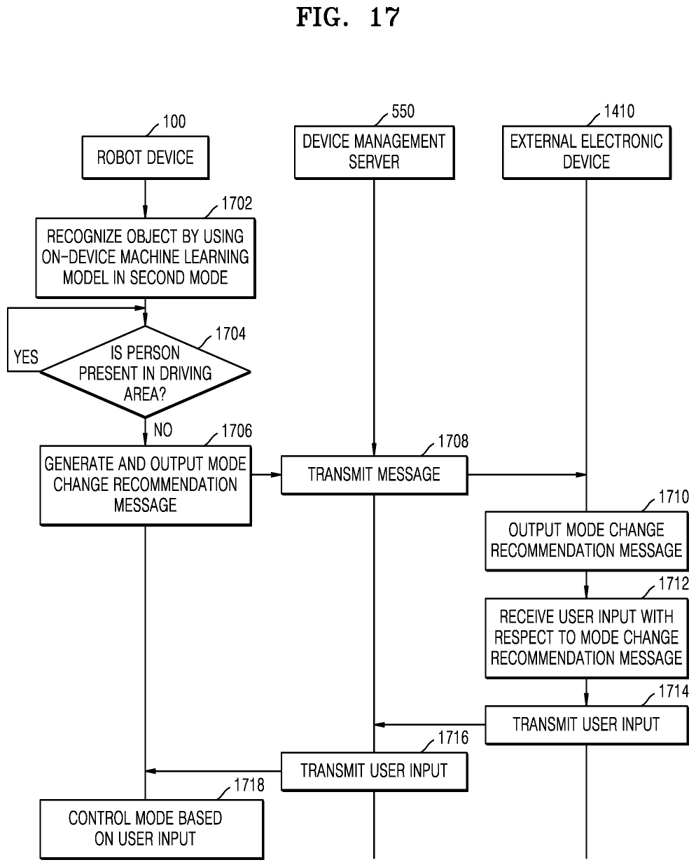

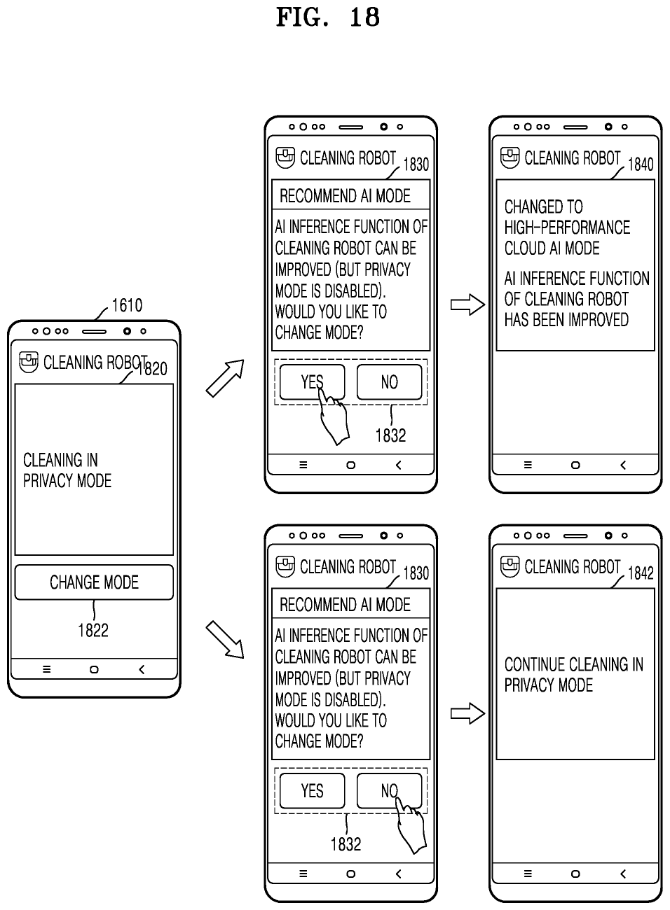

According to an embodiment of the disclosure, when it is determined that no person is present in a driving area while operating in the second mode and the first mode is recommended, the robot device 100 may output the mode change recommendation message together to an external electronic device connected directly or through the device management server 550 to the robot device 100. A configuration for outputting the mode change recommendation message to the external electronic device while operating in the second mode is described with reference to FIGS. 17 and 18.

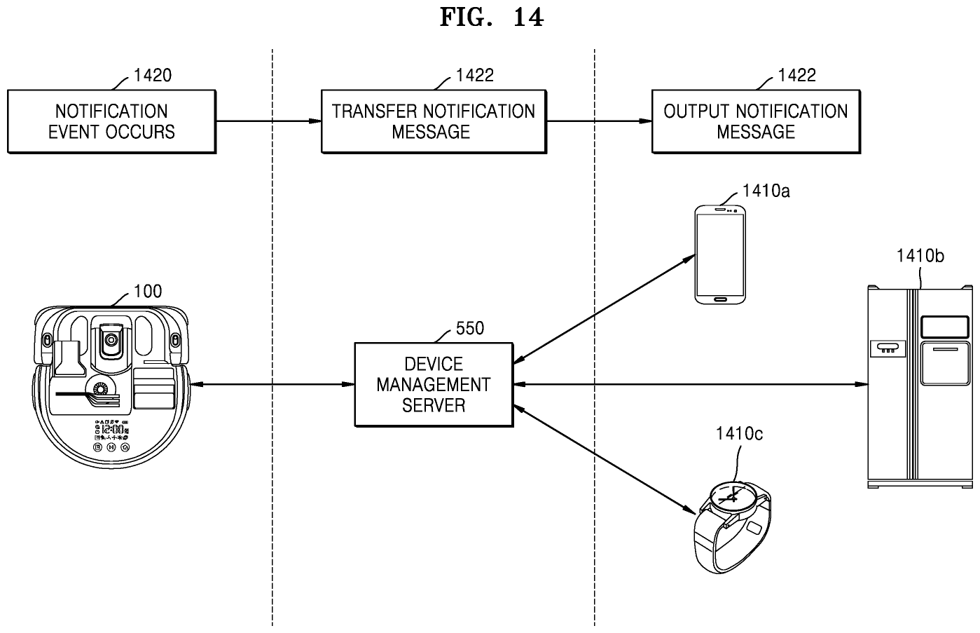

FIG. 14 is a diagram illustrating a process in which a robot device transmits a mode change notification according to an embodiment of the disclosure.

According to an embodiment of the disclosure, the robot device 100 may output the notification message through another electronic device when a mode conversion recommendation event or a mode change event occurs. The robot device 100 may be connected to one or more other electronic devices 1410a, 1410b, and 1410c through the device management server 550. When a notification event including the mode conversion recommendation event or the mode change event occurs in the robot device 100 (1420), the robot device 100 transmits information about the notification event to the device management server 550. The device management server 550 may transfer a notification message corresponding to the notification event to the other electronic devices 1410a, 1410b, and 1410c (1422).

The device management server 550 is a server that manages the one or more electronic devices 100, 1410a, 1410b, and 1410c. The device management server 550 may register and manage the one or more electronic devices 100, 1410a, 1410b, and 1410c through a registered user account. The device management server 550 is connected to the robot device 100 and the one or more electronic devices 1410a, 1410b, and 1410c over a wired or wireless network. The one or more electronic devices 1410a, 1410b, and 1410c may include various types of mobile devices and home appliances. For example, the one or more electronic devices 1410a, 1410b, 1410c may include a smart phone, a wearable device, a refrigerator, a washing machine, an air conditioner, an air purifier, a clothing care machine, an oven, an induction cooker, etc.

The notification event may include the mode conversion recommendation event or the mode change event. The notification event may include various notification events, such as a cleaning start notification, a cleaning completion notification, a cleaning status notification, an impurities detection notification, a low battery notification, a charging start notification, a charging completion notification, etc. in addition to the above-described event.

As described above, the mode conversion recommendation event is an event that recommends a mode change. When a message corresponding to the mode conversion recommendation event is transmitted to the other electronic devices 1410a, 1410b, and 1410c, the device management server 550 may request a user selection signal for the mode change through the other electronic devices 1410a, 1410b, and 1410c, and transfer the user selection signal received through at least one of the other electronic devices 1410a, 1410b, and 1410c to the robot device 100.

The mode change event is an event notifying that the mode has been changed. When a message corresponding to the mode change event is transferred to the other electronic devices 1410a, 1410b, and 1410c, the device management server 550 requests the other electronic devices 1410a, 1410b, and 1410c to output the message. A user response to the message corresponding to the mode change event through the other electronic devices 1410a, 1410b, and 1410c is not required.

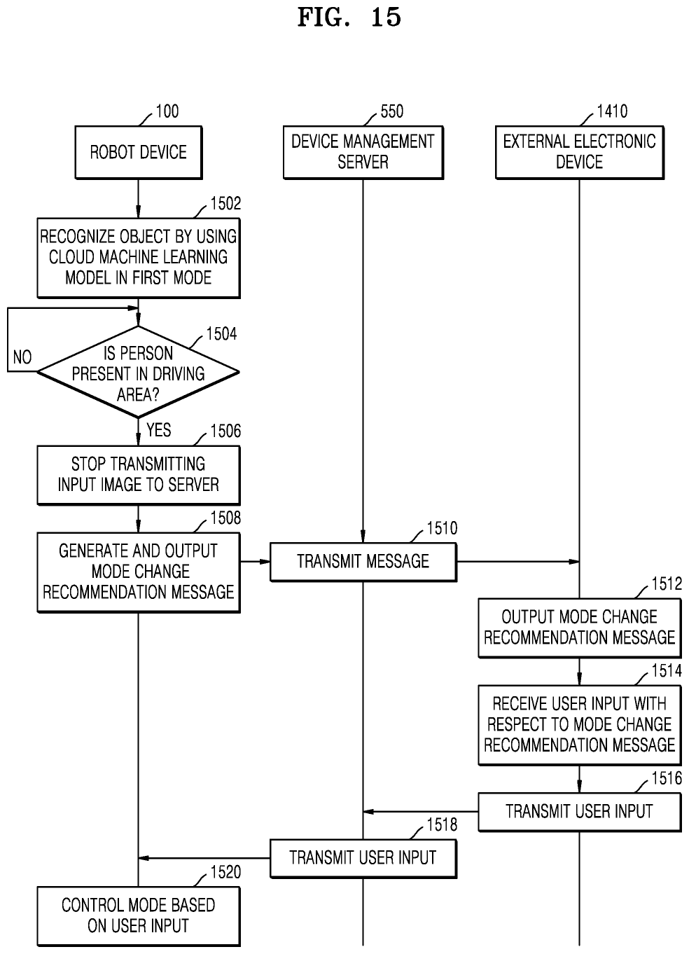

FIG. 15 is a flowchart illustrating a process of outputting a notification through an external electronic device when a mode conversion recommendation event occurs in a first mode according to an embodiment of the disclosure.

According to an embodiment of the disclosure, when the mode change recommendation event occurs while operating in the first mode, the robot device 100 may transfer a mode change recommendation message through an external electronic device 1410 and receive a user input. The external electronic device 1410 is a device registered in a user account of the device management server 550.

The device management server 550 may transfer the mode change recommendation message to some of external electronic devices registered in the user account and capable of outputting a message and receiving a user input. For example, when a smartphone, a wearable device, a refrigerator, a washing machine, an air conditioner, and an oven are registered in the user account, the device management server 550 may transfer the mode change recommendation message to the smartphone, the wearable device, and the refrigerator, and may not transfer the mode change recommendation message to the washing machine, air conditioner, and the oven.

The device management server 550 may determine a type of device to transfer the message according to a type of message. For example, the device management server 550 may transfer the message by selecting an external electronic device including a display of a certain size or larger capable of outputting the message. In addition, when a message requires a user response, the device management server 550 may transfer the message by selecting an external electronic device including a display and an input interface (e.g., a button, a touch screen, etc.). According to an embodiment of the disclosure, the device management server 550 may classify the mode change recommendation message as a message requiring a response, and transfer the message to an electronic device (e.g., a smartphone and a wearable device) including both an output interface and an input interface of a certain criterion or higher. As another example, the device management server 550 may classify the mode change notification message as a message that does not require a response, and transfer the message to an electronic device (e.g., a smartphone, a wearable device, and a refrigerator) including an output interface of a certain standard or higher.

A process of transferring the mode change recommendation message to the external electronic device in the first mode is described in detail with reference to FIG. 15.

The robot device 100 recognizes an object by using the cloud machine learning model 110 in the first mode (1502), and determines whether a person is present in a driving area (1504). When the robot device 100 determines that the person is present in the driving area (1504), the robot device 100 stops transmitting an input image to the server 112 (1506). Next, the robot device 100 generates and outputs the mode change recommendation message recommending a mode change to the second mode (1508). The robot device 100 outputs the mode change recommendation message through the output interface 1010 of the robot device 100 and transmits the mode change recommendation message to the device management server 550.

Whether to transfer the mode change recommendation message of the robot device 100 to the external electronic device 1410 registered in the device management server 550 and to output the mode change recommendation message through the external electronic device 1410 may be set previously. A user may set previously whether to output a notification related to the robot device 100 through an electronic device registered in a user account. The user may set whether to transfer and output the notification from the robot device 100 to another electronic device, or set whether to transfer and output the notification through one of electronic devices registered in the user account.

When the mode change recommendation message is input from the robot device 100, the device management server 550 transmits the mode change recommendation message to the external electronic device 1410 registered in the user account (1510). The device management server 550 may convert or process the mode change recommendation message according to a type of the external electronic device 1410 and transfer the mode change recommendation message. In addition, the device management server 550 may process and transfer the mode change recommendation message in consideration of a communication standard and an input data standard required by the external electronic device 1410. The device management server 550 selects one of the external electronic devices 1410 to which the mode change recommendation message is to be transferred according to a certain criterion, and transfers the mode change recommendation message to the selected external electronic device 1410. For example, as described above, the device management server 550 may select one of the external electronic devices 1410 to which the mode change recommendation message is to be transferred based on whether the external electronic device 1410 includes an output interface and an input interface of a certain criterion or higher.

When receiving the mode change recommendation message, the external electronic device 1410 outputs the mode change recommendation message through an output interface (1512). The external electronic device 1410 may display the mode change recommendation message or output the mode change recommendation as an audio signal. According to an embodiment of the disclosure, the external electronic device 1410 may execute a device management application that manages at least one electronic device registered in the device management server 550 and output the mode change recommendation message through the device management application. In this case, the mode change recommendation message is output in the form of an application notification.

The external electronic device 1410 receives a user input with respect to the mode change recommendation message (1514). The user input may be one of a user input for selecting a mode change and a user input for selecting a current mode maintenance. According to an embodiment of the disclosure, the external electronic device 1410 may receive various types of user inputs for controlling an operation of the device, such as a user input for selecting to stop cleaning.

When a user input is received, the external electronic device 1410 transmits the received user input to the device management server 550 (1516). When a user input is received from one of the external electronic devices 1410, the device management server 550 transmits the received user input to the robot device 100 (1518).

According to an embodiment of the disclosure, when the mode change recommendation message is transmitted to a plurality of external electronic devices 1410 and one of the external electronic devices 1410 receives a user input, the remaining external electronic devices 1410 may stop outputting the mode change recommendation message. To this end, when a user input is received from one of the external electronic devices 1410, the device management server 550 may allow the remaining external electronic devices 1410 to stop outputting the mode change recommendation message by transferring information indicating that a response to the mode change recommendation message has been completed or a control signal requesting to stop outputting the mode change recommendation message to the remaining external electronic devices 1410 that output the mode change recommendation message. When the mode change recommendation message is output through the robot device 100 and the at least one external electronic device 1410 and a user input is received through the robot device 100, the robot device 100 may transfer the information indicating that the response to the mode change recommendation message has been completed or the control signal requesting to stop outputting the mode change recommendation message to the device management server 550. When the device management server 550 receives the information indicating that the response to the mode change recommendation message has been completed or the control signal requesting to stop outputting the mode change recommendation message from the robot device 100, the device management server 550 may allow the remaining external electronic devices 1410 to stop outputting the mode change recommendation message by transferring the information indicating that the response to the mode change recommendation message has been completed or the control signal requesting to stop outputting the mode change recommendation message to the remaining external electronic devices 1410.

When receiving a user input from the device management server 550, the robot device 100 controls the mode of the robot device 100 based on the user input (1520). When receiving a user input for selecting a mode change, the robot device 100 changes the operation mode to the second mode. The robot device 100 maintains the operation mode as the first mode when receiving a user input for selecting the current mode maintenance.

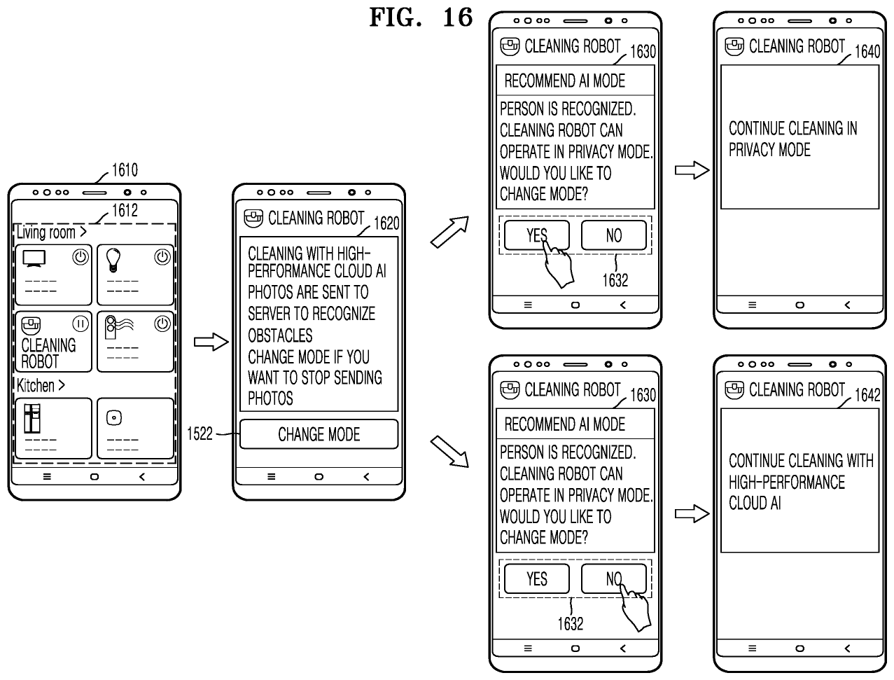

FIG. 16 is a diagram illustrating a process of outputting a mode change recommendation message through an external device according to an embodiment of the disclosure.

According to an embodiment of the disclosure, a mode change recommendation message may be output through a mobile device 1610 communicating with the robot device 100 through the device management server 550, and registered in a user account of the device management server 550. The mobile device 1610 may include a communication interface and a processor. The mobile device 1610 installs and executes a first application providing a function of the device management server 550. The mobile device 1610 may provide device information registered in the device management server 550 and information provided by the device management server 550 through the first application. Also, the mobile device 1610 may provide status information of the robot device 100 and a GUI for controlling the robot device 100.

The mobile device 1610 may provide at least one device information 1612 registered in a user account. The mobile device 1610 may indicate attribute information, operation information, location information, etc. to each device. In addition, the mobile device 1610 outputs event information when a notification event occurs in the at least one device information registered in the user account.

When the robot device 100 is registered in the device management server 550, the mobile device 1610 outputs an operating state of the robot device 100 through the first application. When the robot device 100 is operating in a first mode, the first application may output information 1620 indicating that the robot device 100 is operating by using the cloud machine learning model 110. Also, the mobile device 1610 may provide a selection menu 1622 capable of changing an operation mode of the robot device 100 to a second mode through the first application.

The mobile device 1610 outputs the mode change recommendation message 1630 when receiving information that a mode conversion recommendation event has occurred from the device management server 550. The mobile device 1610 may provide a selection menu 1632 through which a user may select whether to change a mode together with the mode change recommendation message 1630. When receiving a user input, the mobile device 1610 transfers the user input to the device management server 550. The device management server 550 transmits the user input to the robot device 100.

When the user selects a mode change and the operation mode of the robot device 100 is changed to the second mode according to the user input, the mobile device 1610 outputs status information 1640 indicating that the operation mode of the robot device 100 has been changed to the second mode. When the user selects an option not to change the mode and the robot device 100 resumes cleaning in the first mode according to the user input, the mobile device 1610 outputs status information 1642 indicating that the robot device 100 continues cleaning in the first mode.

FIG. 17 is a flowchart illustrating a process of outputting a notification through an external electronic device when a mode conversion recommendation event occurs in a second mode according to an embodiment of the disclosure.

The robot device 100 recognizes an object by using the on-device machine learning model 120 in the second mode (1702), and determines whether a person is present in a driving area (1704). When the robot device 100 determines that a person is present in the driving area (1704), the robot device 100 generates and outputs a mode change recommendation message recommending a mode change to a first mode (1706). The robot device 100 outputs the mode change recommendation message through an output interface of the robot device 100 and transmits the mode change recommendation message to the device management server 550.

When the mode change recommendation message is input from the robot device 100, the device management server 550 transmits the mode change recommendation message to the external electronic device 1410 registered in a user account (1708). The device management server 550 selects one or more of the external electronic devices 1410 to which the mode change recommendation message is to be transferred according to a certain criterion, and transfers the mode change recommendation message to the selected external electronic device 1410.

When receiving the mode change recommendation message, the external electronic device 1410 outputs the mode change recommendation message through the output interface (1710). The external electronic device 1410 may display the mode change recommendation message or output the mode change recommendation as an audio signal.

The external electronic device 1410 receives a user input with respect to the mode change recommendation message (1712). The user input may be one of a user input for selecting a mode change and a user input for selecting a current mode maintenance.

When a user input is received, the external electronic device 1410 transmits the received user input to the device management server 550 (1714). When a user input is received from one of the external electronic devices 1410, the device management server 550 transmits the received user input to the robot device 100 (1716).

When receiving a user input from the device management server 550, the robot device 100 controls the mode of the robot device 100 based on the user input (1718). When receiving a user input for selecting a mode change, the robot device 100 changes the operation mode to the first mode. The robot device 100 maintains the operation mode as the first mode when receiving a user input for selecting the current mode maintenance.

FIG. 18 is a diagram illustrating a process of outputting a mode change recommendation message through an external device according to an embodiment of the disclosure.

When the robot device 100 is registered in the device management server 550, the mobile device 1610 outputs an operating state of the robot device 100 through a first application. When the robot device 100 is operating in a second mode, the first application may output information 1820 indicating that the robot device 100 is operating by using the on-device machine learning model 120. Also, the mobile device 1610 may provide a selection menu 1822 capable of changing an operation mode of the robot device 100 to a first mode.

When the mobile device 1610 receives information that a mode conversion recommendation event has occurred from the device management server 550, the mobile device 1610 outputs a mode change recommendation message 1830. The mobile device 1610 may provide a selection menu 1832 through which a user may select whether to change a mode together with the mode change recommendation message 1830. When receiving a user input, the mobile device 1610 transfers a user input to the device management server 550. The device management server 550 transmits the user input to the robot device 100.

When the user selects a mode change and the operation mode of the robot device 100 is changed to the first mode according to the user input, the mobile device 1610 outputs status information 1640 indicating that the operation mode of the robot device 100 has been changed to the first mode. When the user selects an option not to change the mode and the robot device 100 resumes cleaning in the second mode according to the user input, the mobile device 1610 outputs status information 1842 indicating that the robot device 100 continues cleaning in the second mode.

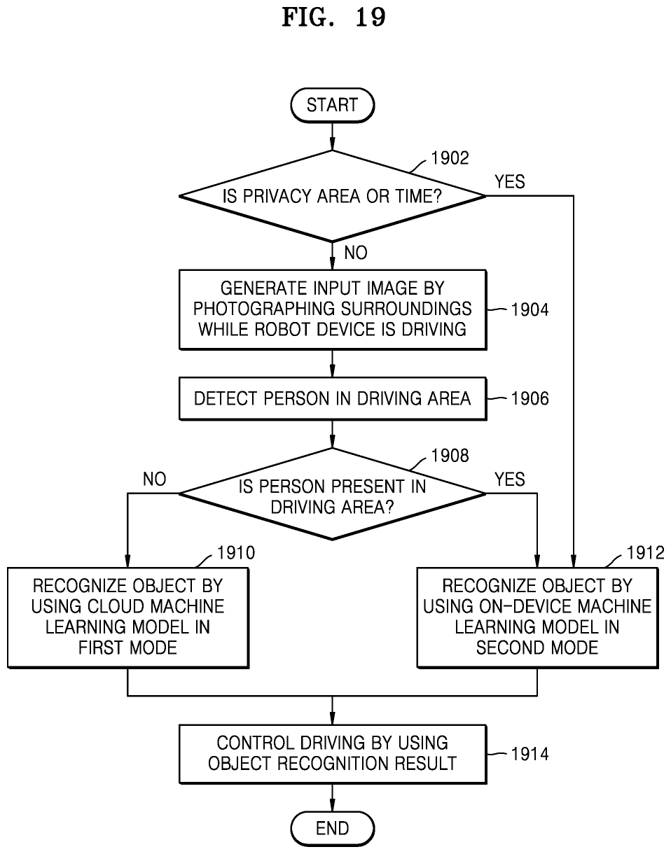

FIG. 19 is a flowchart illustrating an operation of setting a privacy area or privacy time according to an embodiment of the disclosure.

According to an embodiment of the disclosure, the robot device 100 may set the privacy area or the privacy time that always operates in a second mode by using the on-device machine learning model 120 regardless of whether a person is present According to an embodiment of the disclosure, the robot device 100 may set the privacy area. According to another embodiment of the disclosure, the robot device 100 may set the privacy time. According to another embodiment of the disclosure, the robot device 100 may set both the privacy area and the privacy time.

The privacy area means a certain area within a driving area. According to an embodiment of the disclosure, the privacy area may be set as a sub driving area within the driving area. For example, the driving area may include a plurality of sub driving areas corresponding to a room, a living room, or a kitchen, and the privacy area may be selected from among the plurality of sub driving areas. The privacy area may not be set, and one or more sub driving areas may be set as privacy areas. For example, a bedroom 1 may be set as the privacy area. As another example, the privacy area may be an area arbitrarily set by a user within the driving area. The robot device 100 may receive a user input for setting the privacy area through a user interface of the robot device 100 or a user interface of another electronic device connected thereto through the device management server 550.

The privacy time means a time period specified by the user. The privacy time may be set once or repeatedly. The privacy time may be set by selecting a day of the week, or by selecting weekdays or weekends. Also, the privacy time may be designated and selected as a specific time period. The robot device 100 may receive a user input for setting the privacy time through the user interface of the robot device 100 or the user interface of another electronic device connected thereto through the device management server 550.

An operation of the robot device 100 when the privacy area or the privacy time is set is described with reference to FIG. 19.

When the robot device 100 starts an operation, the robot device 100 determines whether a current driving area corresponds to the privacy area (1902). Also, when the robot device 100 starts an operation, the robot device 100 determines whether current day and time correspond to the privacy time (1902). When the current driving area corresponds to the privacy area or the current time corresponds to the privacy time, the robot device 100 sets an operation mode to a second mode and uses the on-device machine learning model 120 to recognize an object (1912). In this case, the robot device 100 may set the operation mode to the second mode without determining whether a person is present in the driving area.

The robot device 100 performs a process of determining whether a person is present when a current driving point does not correspond to the privacy area. In addition, when a current time point does not correspond to the privacy time, the robot device 100 performs the process of determining whether the person is present. According to a configuration of the robot device 100, the robot device 100 may determine whether a current driving point corresponds to the privacy area, whether a current time point corresponds to the privacy time, or whether the current driving point and the current time point corresponds to the privacy area and the privacy time respectively.

When the current driving point or the current time point does not correspond to the privacy area or the privacy time, the robot device 100 generates an input image by photographing surroundings while the robot device 100 is driving (1904). Also, the robot device 100 detects a person in the driving area (1906) and determines whether the person is present in the driving area (1908). The robot device 100 recognizes an object from the input image by using the cloud machine learning model 110 in a first mode when no person is present in the driving area (1910). When a person is present in the driving area, the robot device 100 recognizes an object from the input image by using the on-device machine learning model 120 in the second mode (1912).

The robot device 100 controls driving of the robot device 100 by using an object recognition result of the cloud machine learning model 110 or the on-device machine learning model 120 (1914).

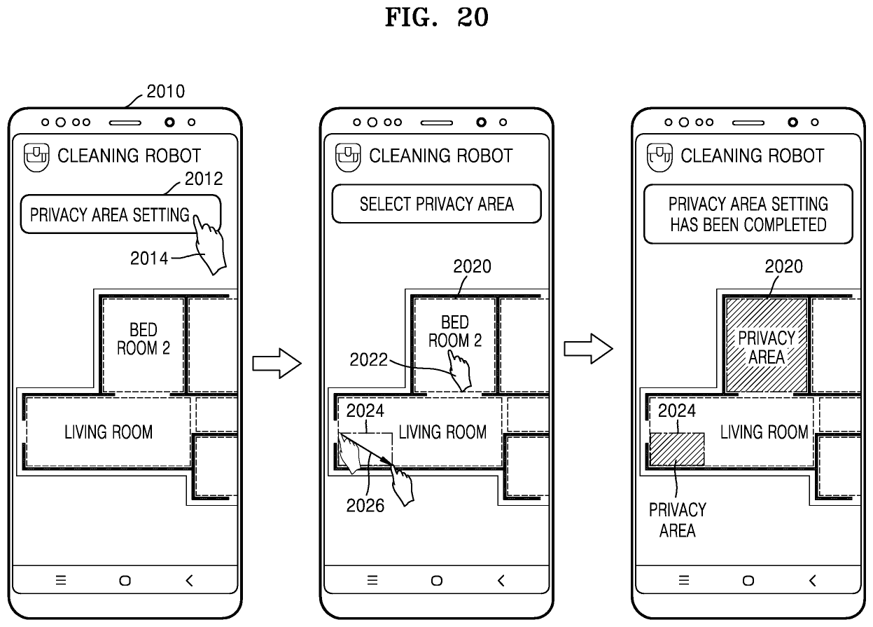

FIG. 20 is a diagram illustrating a process of setting a privacy area according to an embodiment of the disclosure.

According to an embodiment of the disclosure, the privacy area of the robot device 100 may be set by using an external electronic device 2010 registered in a user account of the device management server 550. The external electronic device 2010 may correspond to, for example, a communication terminal including a touch screen, a tablet PC, a desktop PC, a laptop PC, a wearable device, a television, or a refrigerator. The external electronic device 2010 may include a display and an input interface (e.g., a touch screen, a mouse, a keyboard, a touch pad, key buttons, etc.)

The external electronic device 2010 executes a first application that manages electronic devices registered in the device management server 550. The first application may provide a privacy area setting menu 2012 capable of setting the privacy area of the robot device 100. When in operation 2014, a user selects the privacy area setting menu 2012, the first application outputs driving space information 2016. The driving space information 2016 may include one or more sub driving areas.

Setting of the privacy area may be performed based on a selection input 2022 through which the user selects a sub driving area or an area setting input 2026 through which the user arbitrarily sets an area. When the user selects one of the sub driving areas (2020) as the privacy area (2022), the first application sets the selected area as the privacy area. In addition, the first application may set an arbitrary area 2024 set by the user as the privacy area.

Privacy area information generated by the first application of the external electronic device 2010 is transferred to the device management server 550, and the device management server 550 transmits the privacy area information to the robot device 100. The robot device 100 controls driving of the robot device 100 based on the privacy area information received from the device management server 550.

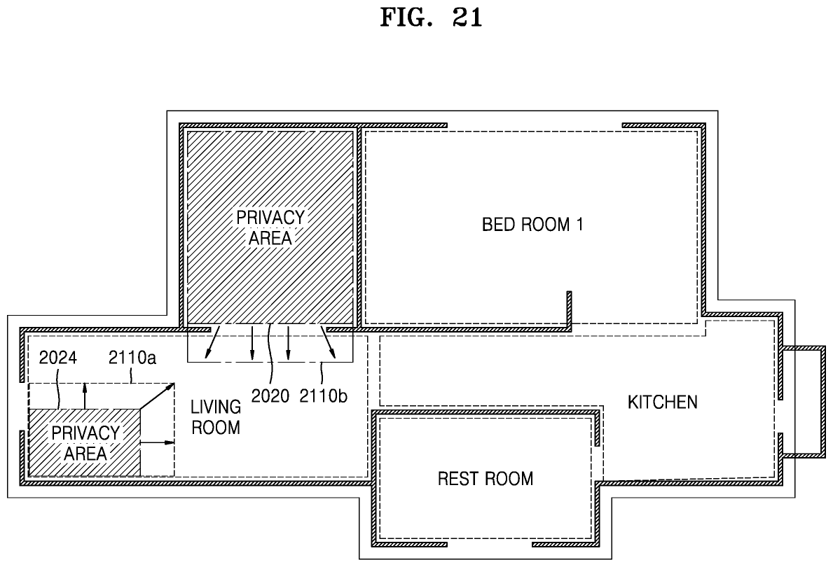

FIG. 21 is a diagram illustrating a process of setting a privacy area and a photographing prohibition area according to an embodiment of the disclosure.

According to an embodiment of the disclosure, when the privacy areas 2020 and 2024 are set in a driving area of the robot device 100, in order to prevent an input image obtained by photographing the privacy areas 2020 and 2024 from being transmitted to the server 112, image transmission prohibition areas 2110a and 2110b including the privacy areas 2020 and 2024 and including points where the privacy areas 2020 and 2024 may be photographed may be set. The image transmission prohibition areas 2110a and 2110b include the privacy areas 2020 and 2024 and may be set to wider areas than the privacy areas 2020 and 2024.

The image transmission prohibition areas 2110a and 2110b may be set in consideration of a FOV and an AOV of the camera 220 at each point of the robot device 100. The robot device 100 or the device management server 550 may set the image transmission prohibition areas 2110a and 2110b based on the privacy areas 2020 and 2024. The robot device 100 or the device management server 550 defines points within the FOV of the camera 220 where the privacy areas 2020 and 2024 are photographed, and set the points within the FOV where the privacy areas 2020 and 2024 are photographed as the image transmission prohibition areas 2110a and 2110b. When the privacy area 2020 is set to one of sub driving areas, the image transmission prohibition area 2110b may be set to a certain area around an area where a door to the sub driving area is disposed. When the privacy area 2024 is set to an arbitrary area, the image transmission prohibition area 2110a may be set as a certain area around an open boundary where no furniture or wall is disposed by determining whether furniture or wall is disposed around the privacy area 2024.

When the privacy areas 2020 and 2024 are set, the robot device 100 may operate in a second mode in the image transmission prohibition areas 2110a and 2110b. A user actually sets the privacy areas 2020 and 2024, but in order to protect user privacy, the robot device 100 or the device management server 550 may extend an area that always operates in the second mode regardless of whether a person is present to the image transmission prohibition areas 2110a and 2110b.

According to an embodiment of the disclosure, whether to set the image transmission prohibition areas 2110a and 2110b may be selected through the robot device 100 or the external electronic device 2010. Also, information about the image transmission prohibition areas 2110a and 2110b may be provided through the robot device 100 or the external electronic device 2010. In addition, a GUI capable of setting and editing the image transmission prohibition areas 2110a and 2110b may be provided through the robot device 100 or the external electronic device 2010.

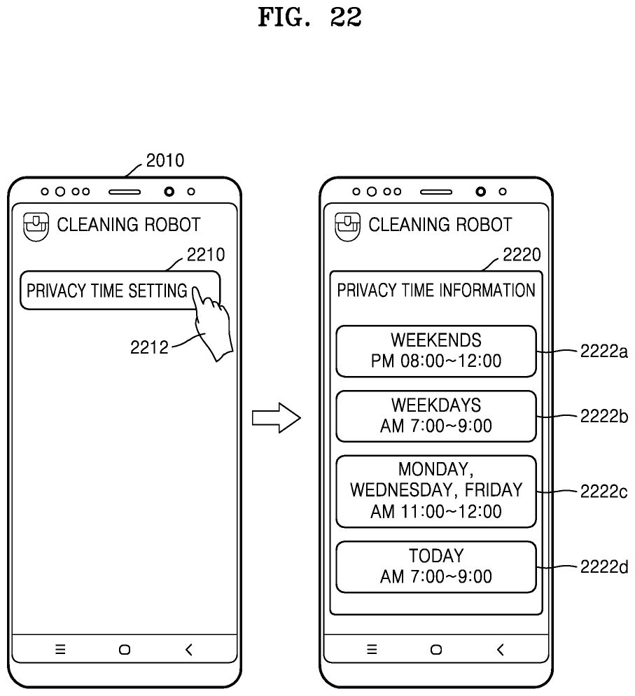

FIG. 22 is a diagram illustrating a process of setting a privacy time according to an embodiment of the disclosure.

According to an embodiment of the disclosure, the privacy time of the robot device 100 may be set by using the external electronic device 2010 registered in a user account of the device management server 550.

The external electronic device 2010 executes a first application that manages electronic devices registered in the device management server 550. The first application may provide a privacy time setting menu 2210 capable of setting the privacy time of the robot device 100. When a user selects the privacy area setting menu 2210 (2212), the first application provides a GUI through which a user may set the privacy time.

When the privacy time is set, the first application may output set privacy time information 2220. The privacy time may be set to various dates and times. The privacy time may be set repeatedly (2222a, 2222b, and 2222c) or set only once (2222d). Also, the privacy time may be set to weekends (2222a) or weekdays (2222b), or may be set by selecting a specific day (2222c).

Privacy time information generated by the first application of the external electronic device 2010 is transferred to the device management server 550, and the device management server 550 transmits the privacy time information to the robot device 100. The robot device 100 controls driving of the robot device 100 based on the privacy time information received from the device management server 550.

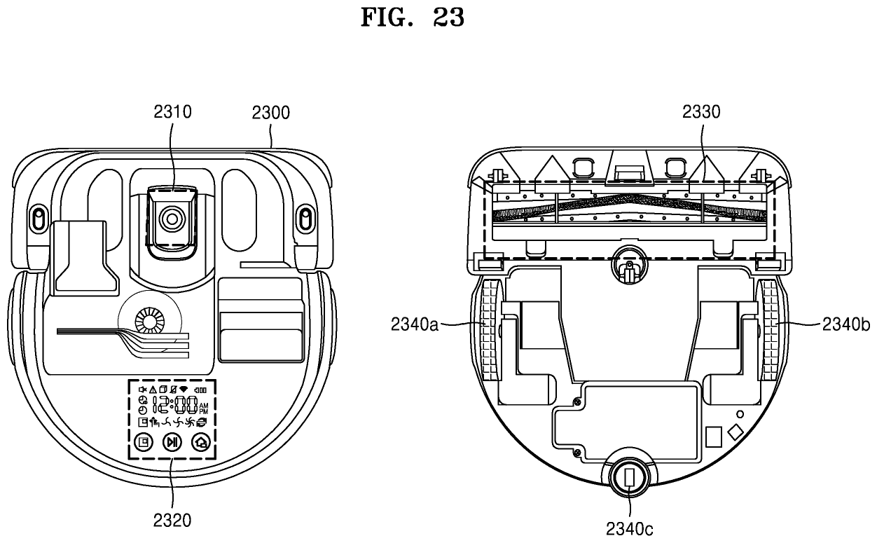

FIG. 23 is a diagram illustrating an example of the robot device 100 according to an embodiment of the disclosure.

The robot device 100 according to an embodiment of the disclosure is implemented in the form of a cleaning robot 2300. The cleaning robot 2300 includes a camera 2310 and an input/output interface 2320 on its upper surface. The camera 2310 may correspond to the camera 220 of FIG. 2 described above, and the input/output interface 2320 may correspond to the output interface 1010 described above. The camera 2310 may operate so that a FOV of the camera 2310 faces the front of the cleaning robot 2300 in a driving direction according to an operating state. For example, while a housing around the camera 2310 moves according to the operating state of the cleaning robot 2300, the camera 2310 may move from a direction of the FOV facing the top to a direction of the FOV facing the front.

In addition, the cleaning robot 2300 includes a cleaning assembly 2330 and moving assembly 2340a, 2340b, and 2340c on its lower surface. The cleaning assembly 2330 includes at least one of a vacuum cleaning module or a wet mop cleaning module or a combination thereof. The vacuum cleaning module includes a dust bin, a brush, a vacuum sucker, etc., and performs a vacuum suction operation. The wet mop cleaning module includes a water container, a water supply module, a wet mop attachment part, a wet mop, etc., and performs a wet mop cleaning operation. The moving assembly 2340a, 2340b, and 2340c includes at least one wheel, a wheel driving unit, etc., and moves the cleaning robot 2300.

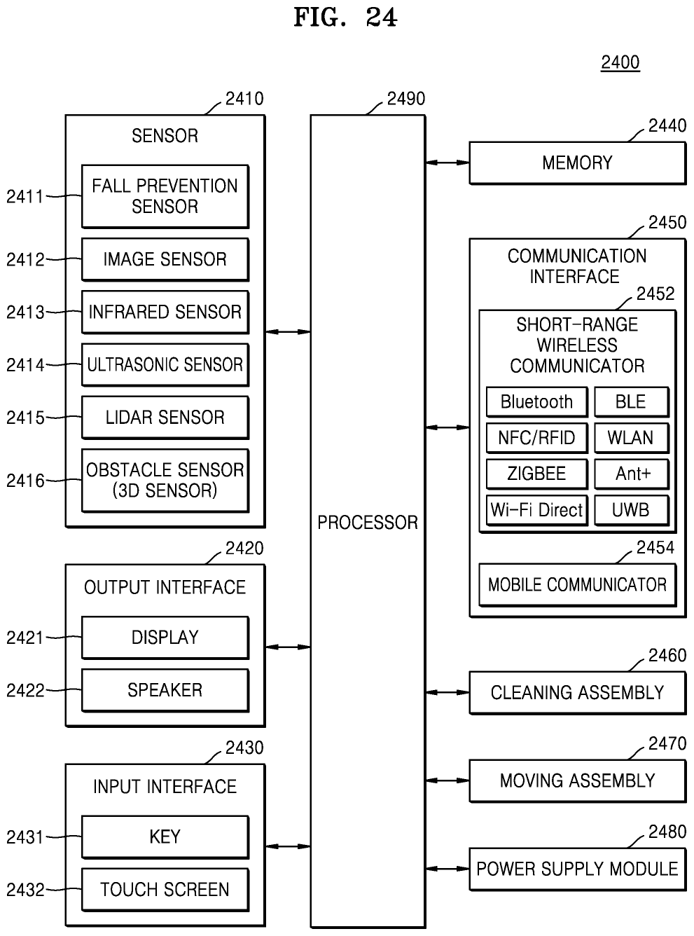

FIG. 24 is a block diagram of a structure of a cleaning robot according to an embodiment of the disclosure.

A cleaning robot 2400 according to an embodiment of the disclosure includes a sensor 2410, an output interface 2420, an input interface 2430, a memory 2440, a communication interface 2450, a cleaning assembly 2460, a moving assembly 2470, a battery 2480, and a processor 2490. The cleaning robot 2400 may be configured in various combinations of the components shown in FIG. 24, and the components shown in FIG. 24 are not all indispensable components.

The cleaning robot 2400 of FIG. 24 corresponds to the robot device 100 described with reference to FIG. 2, an image sensor 2412 corresponds to the camera 220 described with reference to FIG. 2, the output interface 2420 corresponds to the output interface 1010 described with reference to FIG. 10, the processor 2490 corresponds to the processor 210 described with reference to FIG. 2, the communication interface 2450 corresponds to the communication interface 230 described with reference to FIG. 2, and the moving assembly 2470 corresponds to the moving assembly 240 described with reference to FIG. 2.

The sensor 2410 may include various types of sensors, and may include, for example, at least one of a fall prevention sensor 2411, the image sensor 2412, an infrared sensor 2413, an ultrasonic sensor 2414, a lidar sensor 2415, an obstacle sensor 2416, or a mileage detection sensor (not shown) or a combination thereof. The mileage detection sensor may include a rotation detection sensor that calculates the number of rotations of a wheel. For example, the rotation detection sensor may have an encoder installed to detect the number of rotations of a motor. A plurality of image sensors 2412 may be disposed in the cleaning robot 2400 according to an embodiment of the disclosure. Functions of each sensor may be intuitively inferred by one of ordinary skill in the art from the name, detailed descriptions thereof will be omitted.

The output interface 2420 may include at least one of a display 2421 or a speaker 2422, or a combination thereof. The output interface 2420 outputs various notifications, messages, and information generated by the processor 2490.

The input interface 2430 may include a key 2431, a touch screen 2432, etc. The input interface 2430 receives a user input and transmits the user input to the processor 2490.

The memory 2440 stores various types of information, data, an instruction, a program, etc. required for operations of the cleaning robot 2400. The memory 2440 may include at least one of a volatile memory and a nonvolatile memory, or a combination thereof. The memory 2440 may include at least one type of storage medium among a flash memory type, a hard disk type, a multimedia card micro type, a card type memory (e.g., a secure digital (SD) or an extreme digital (XD) memory), random access memory (RAM), static RAM (SRAM), read-only memory (ROM), electrically erasable programmable ROM (EEPROM), programmable ROM (PROM), a magnetic memory, a magnetic disk, or an optical disk. Also, the cleaning robot 2400 may correspond to a web storage or cloud server performing a storing function on the Internet.

The communication interface 2450 may include at least one or a combination of a short-range wireless communicator 2452 or a mobile communicator 2454. The communication interface 2450 may include at least one antenna for communicating with another device wirelessly.

The short-range wireless communicator 2452 may include a Bluetooth communicator, a Bluetooth low energy (BLE) communicator, a near field communicator, a wireless local region network (WLAN) (Wi-Fi) communicator, a Zigbee communicator, an infrared data association (IrDA) communicator, a Wi-Fi direct (WFD) communicator, an ultra-wideband (UWB) communicator, and an Ant+ communicator, but is not limited thereto.

The mobile communicator 2454 may transmit or receive a wireless signal to or from at least one of a base station, an external terminal, or a server, on a mobile communication network. Here, the wireless signal may include various types of data according to exchange of a voice call signal, an image call signal, or a text/multimedia message.

The cleaning assembly 2460 may include a main brush assembly installed on a lower portion of a main body to sweep or scatter dust on the floor and to suck the swept or scattered dust and a side brush assembly installed on the lower part of the main body so as to protrude to the outside and sweeping dust from a region different from a region cleaned by the main brush assembly and delivering the dust to the main brush assembly. Also, the cleaning assembly 2460 may include a vacuum cleaning module performing vacuum suction or a wet mop cleaning module cleaning with a wet mop.

The moving assembly 2470 moves the main body of the cleaning robot 2400. The moving assembly 2470 may include a pair of wheels that move forward, backward, and rotate the cleaning robot 2400, a wheel motor that applies a moving force to each wheel, and a caster wheel installed in front of the main body and of which angle is changed by rotating according to a state of a floor surface on which the cleaning robot 2400 moves, etc. The moving assembly 2470 moves the cleaning robot 2400 according to the control by the processor 2490. The processor 2490 determines a driving path and controls the moving assembly 2470 to move the cleaning robot 2400 along the determined driving path.

The power supply module 2480 supplies power to the cleaning robot 2400. The power supply module 2480 includes a battery, a power driving circuit, a converter, a transformer circuit, etc. The power supply module 2480 connects to a charging station to charge the battery, and supplies the power charged in the battery to the components of the cleaning robot 2400.

The processor 2490 controls all operations of the cleaning robot 2400. The processor 2490 may control the components of the cleaning robot 2400 by executing a program stored in the memory 2440.

According to an embodiment of the disclosure, the processor 2490 may include a separate NPU performing an operation of a machine learning model. In addition, the processor 2490 may include a central processing unit (CPU), a graphics processing unit (GPU), etc.

The processor 2490 may perform operations such as operation mode control of the cleaning robot 2400, driving path determination and control, obstacle recognition, cleaning operation control, location recognition, communication with an external server, remaining battery monitoring, battery charging operation control, etc.

The term “module” used in various embodiments of the disclosure may include a unit implemented in hardware, software, or firmware, and for example, may be interchangeably used with a term such as a logic, a logic block, a component, or a circuit. The module may be an integrally configured component, a minimum unit of the component, which perform one or more functions, or a part of the component. For example, according to an embodiment of the disclosure, the module may be configured in a form of an application-specific integrated circuit (ASIC).

Various embodiments of the disclosure may be implemented as software (e.g., a program) including one or more instructions stored in a storage medium readable by a machine (e.g., the robot device 100). For example, a processor of the machine (e.g., the robot device 100) may invoke at least one instruction from among the one or more instructions stored in the storage medium, and execute the at least one instruction. Accordingly, the machine is enabled to operate to perform at least one function according to the at least one invoked instruction. The one or more instructions may include code generated by a compiler or code executable by an interpreter. The machine-readable storage medium may be provided in a form of a non-transitory storage medium. Here, ‘non-transitory’ only means that the storage medium is a tangible device and does not contain a signal (for example, electromagnetic waves). This term does not distinguish a case where data is stored in the storage medium semi-permanently and a case where data is stored in the storage medium temporarily.

According to an embodiment of the disclosure, a method according to various embodiments of the disclosure may be provided by being included in a computer program product. The computer program products are products that may be traded between sellers and buyers. The computer program product may be distributed in a form of machine-readable storage medium (for example, a compact disc read-only memory (CD-ROM)), or distributed (for example, downloaded or uploaded) through an application store, or directly or online between two user devices (for example, smartphones). In the case of online distribution, at least a part of the computer program product may be at least temporarily stored or temporarily generated in the machine-readable storage medium such as a server of a manufacturer, a server of an application store, or a memory of a relay server.

According to various embodiments, each component (e.g., module or program) of the above-described components may include a single or plurality of entities, and some of the plurality of entities may be separately arranged in another component. According to various embodiments, one or more components among the above-described components, or one or more operations may be omitted, or one or more other components or operations may be added. Alternatively or additionally, a plurality of components (e.g., modules or programs) may be integrated into one component. In this case, the integrated component may perform one or more functions of each of the plurality of components in a same or similar manner as a corresponding component among the plurality of components before the integration. According to various embodiments, operations performed by modules, programs, or other components may be sequentially, parallelly, repetitively, or heuristically executed, one or more of the operations may be executed in a different order or omitted, or one or more other operations may be added.

What is claimed is:

1. A robot device comprising:
a moving assembly configured to move the robot device;
a camera configured to generate an image signal by photographing surroundings of the robot device during driving of the robot device;
a communication interface; and
at least one processor configured to:
detect a person in a driving area of the robot device,
based on a determination that no person is present in the driving area, recognize an object in an input image generated from the image signal using a cloud machine learning model, in a first mode,
based on a determination that a person is present in the driving area, recognize the object in the input image generated from the image signal using an on-device machine learning model, in a second mode, and
control the driving of the robot device through the moving assembly by using a result of recognizing the object,
wherein the cloud machine learning model operates on a cloud server connected through the communication interface, and the on-device machine learning model operates on the robot device.

2. The robot device of claim 1, further comprising: an output interface,
wherein the at least one processor is further configured to
provide a notification recommending changing an operation mode to the second mode through the output interface when it is determined that the person is present in the driving area while operating in the first mode, and
provide a notification recommending changing the operation mode to the first mode through the output interface when it is determined that no person is present in the driving area while operating in the second mode.

3. The robot device of claim 1, wherein the at least one processor is further configured to determine whether the person is present in the driving area based on the object recognition result of the cloud machine learning model or the on-device machine learning model.

4. The robot device of claim 1, wherein
the communication interface is configured to communicate with an external device including a first sensor configured to detect the person in the driving area, and
the at least one processor is further configured to determine whether the person is present in the driving area based on a sensor detection value of the first sensor.

5. The robot device of claim 1, wherein
the communication interface is configured to communicate with an area management system managing a certain area including the driving area, and
the at least one processor is further configured to determine that no person is present in the driving area based on receiving going out information indicating that the area management system is set to a going out mode.

6. The robot device of claim 1, wherein
the communication interface is configured to communicate with a device management server configured to control at least one electronic device registered in a user account, and
the at least one processor is further configured to determine whether the person is present in the driving area based on user location information or going out mode setting information received from another electronic device registered in the user account of the device management server.

7. The robot device of claim 1, wherein the at least one processor is further configured to scan the entire driving area and determine whether the person is present in the driving area based on a scan result of the entire driving area.

8. The robot device of claim 1, wherein
the driving area comprises one or more sub driving areas, and
the at least one processor is further configured to:
recognize the object by operating in the first mode in a first sub driving area in which it is determined that no person is present, wherein the first sub driving area is among the one or more sub driving areas, and
recognize the object by operating in the second mode in a second sub driving area in which it is determined that the person is present, wherein the second sub driving area is among the one or more sub driving areas.

9. The robot device of claim 1, wherein
the on-device machine learning model operates in a normal mode in the second mode, and operates in a light mode with less throughput than the normal mode in the first mode, and
the at least one processor is further configured to
set the on-device machine learning model to the light mode while operating in the first mode,
input the input image to the on-device machine learning model set to the light mode before inputting the input image to the cloud machine learning model,
determine whether the person is detected based on an output of the on-device machine learning model set to the light mode,
based on determining that no person is detected as an output of the on-device machine learning model set to the light mode, input the input image to the cloud machine learning model, and
based on determining that the person is detected as an output of the on-device machine learning model set to the light mode, stop inputting the input image to the cloud machine learning model.

10. The robot device of claim 1, wherein
the at least one processor is further configured to:
provide a notification recommending changing an operation mode to the second mode in response to determining that the person is present in the driving area while operating in the first mode, or
provide a notification recommending changing the operation mode to the first mode in response to determining that no person is present in the driving area while operating in the second mode, and
the notification is output through at least one device registered in a user account of a device management server connected through the communication interface.

11. The robot device of claim 1, wherein the at least one processor is further configured to operate in the second mode in a privacy area, regardless of whether the person is detected, when the privacy area is set in the driving area.

12. The robot device of claim 1, further comprising: a cleaning assembly configured to perform at least one operation of sweeping, vacuum suction, or mop water supply,
wherein the at least one processor is configured to operate the cleaning assembly while driving in the driving area in the first mode and the second mode.

13. A method of controlling a robot device, the method comprising:
generating an input image of the robot device's surroundings during driving of the robot device;
detecting a person in a driving area of the robot device;
based on a determination that no person is present in the driving area, recognizing an object in an input image generated from the image signal using a cloud machine learning model in a first mode;
based on a determination that a person is present in the driving area, recognizing the object in the input image generated from the image signal using an on-device machine learning model in a second mode; and
controlling the driving of the robot device by using a result of recognizing the object,
wherein the cloud machine learning model operates on a cloud server communicating with the robot device, and the on-device machine learning model operates on the robot device.

14. The method of claim 13, further comprising:
providing a notification recommending changing an operation mode to the second mode when it is determined that the person is present in the driving area while operating in the first mode, and
providing a notification recommending changing the operation mode to the first mode when it is determined that no person is present in the driving area while operating in the second mode.

15. The method of claim 13, wherein the on-device machine learning model operates in a normal mode in the second mode, and operates in a light mode with less throughput than the normal mode in the first mode, and
wherein the method further comprises:
setting the on-device machine learning model to the light mode while operating in the first mode,
inputting the input image to the on-device machine learning model set to the light mode before inputting the input image to the cloud machine learning model,
determining whether the person is detected based on an output of the on-device machine learning model set to the light mode,
based on determining that no person is detected as an output of the on-device machine learning model set to the light mode, inputting the input image to the cloud machine learning model, and
based on determining that the person is detected as an output of the on-device machine learning model set to the light mode, stopping the inputting of the input image to the cloud machine learning model.

16. A non-transitory computer readable recording medium storing instructions that, when executed by at least one processor, cause the at least one processor to:
generate n input image of the robot device's surroundings during driving of the robot device;
detect a person in a driving area of the robot device;
based on a determination that no person is present in the driving area, recognize an object in an input image generated from the image signal using a cloud machine learning model in a first mode;
based on a determination that a person is present in the driving area, recognize the object in the input image generated from the image signal using an on-device machine learning model in a second mode; and
control the driving of the robot device by using a result of recognizing the object,
wherein the cloud machine learning model operates on a cloud server communicating with the robot device, and the on-device machine learning model operates on the robot device.

17. The non-transitory computer readable recording medium of claim 16, wherein the instructions further cause the at least one processor to:
provide a notification recommending changing an operation mode to the second mode when it is determined that the person is present in the driving area while operating in the first mode; and
provide a notification recommending changing the operation mode to the first mode when it is determined that no person is present in the driving area while operating in the second mode.

18. The non-transitory computer readable recording medium of claim 16, wherein the instructions further cause the at least one processor to:
set the on-device machine learning model to the light mode while operating in the first mode;
input the input image to the on-device machine learning model set to the light mode before inputting the input image to the cloud machine learning model;
determine whether the person is detected based on an output of the on-device machine learning model set to the light mode;
based on determining that no person is detected as an output of the on-device machine learning model set to the light mode, input the input image to the cloud machine learning model; and
based on determining that the person is detected as an output of the on-device machine learning model set to the light mode, stop inputting the input image to the cloud machine learning model.
